(19) United States
(12) Patent Application Publication
(10) Pub. No.: US 2017/0011378 A1
(43) Pub. Date: Jan. 12, 2017

(54) POS TERMINAL DEVICE, POS SYSTEM, IMAGE PROCESSING METHOD, AND NON-TRANSITORY COMPUTER READABLE MEDIUM STORING PROGRAM

(71) Applicant: NEC CORPORATION, Tokyo (JP)

(72) Inventors: Takanori INOUE, Tokyo (JP); Eiji MURAMATSU, Tokyo (JP); Michio NAGAI, Tokyo (JP); Shinichi ANAMI, Tokyo (JP); Jun KOBAYASHI, Tokyo (JP)

(73) Assignee: NEC Corporation, Tokyo (JP)

(21) Appl. No.: 15/119,456

(22) PCT Filed: Nov. 7, 2014
(86) PCT No.: PCT/JP2014/005618

§ 371 Date: Aug. 17, 2016

(30) Foreign Application Priority Data
Mar. 20, 2014 (JP) 2014-057377

(51) Int. Cl. G06Q 20/20; H04N 7/18; H04N 13/02; G07G 1/00

(52) U.S. Cl. CPC G06Q 20/208; G07G 1/0063; H04N 7/181; H04N 13/0203

(57) ABSTRACT

A POS terminal device capable of extracting a commodity image from an image taken by image pickup means in order to contribute to an improvement in the recognition rate of commodities is provided. A POS terminal device (1) includes at least one image pickup unit (2) and a 3D image generation unit (4), and a commodity image extraction unit (6). The image pickup unit (2) generates a plurality of 2D images by shooting a commodity from a plurality of viewpoints, each of the plurality of 2D images corresponding to a respective one of the plurality of viewpoints. The 3D image generation unit (4) generates a 3D image including an image of the commodity by using the plurality of 2D images generated by the image pickup unit (2). The commodity image extraction unit (6) extracts the image of the commodity by using the 3D image.

### TECHNICAL FIELD

The present invention relates to a POS (Point Of Sales) terminal device, a POS system, an image processing method, and a program. In particular, the present invention relates to a POS terminal device, a POS system, an image processing method, and a non-transitory computer readable medium storing a program used to make a settlement (or payment) for a commodity.

### BACKGROUND ART

In POS (Point Of Sales) terminals installed in settlement places (checkout counters: cash registers) of supermarkets, mass merchandising stores, and the like, a salesclerk enters data of commodities with barcodes attached thereto by using a barcode input device and enters data of commodities to which barcodes cannot be attached by using a keyboard. Therefore, the time necessary for entering data of commodities with no barcodes attached thereto widely varies depending on the level of the skill of the salesclerk. In some cases, a salesclerk attaches store-original barcodes to commodities with no barcodes attached thereto in advance. However, such a task leads to an increase in working hours. Meanwhile, recently, self-checkout counters in which a customer operates a POS terminal device by himself/herself have been increasing. Since it takes time for a customer to find where a barcode is attached to a commodity, the time necessary for operating the POS terminal device further increases.

Therefore, a technique for taking an image (i.e., a picture) of a commodity by using a camera or the like disposed inside a POS terminal device and recognizing the commodity by using an image recognition technique has been proposed. As a related technique, Patent Literature 1 discloses a store system including image output means for outputting an image taken by image pickup means, and object recognition means for recognizing a specific object by reading feature amounts of the output image.

### CITATION LIST

### Patent Literature

Patent Literature 1: Japanese Patent No. 5132732

### SUMMARY OF INVENTION

### Technical Problem

When a commodity is shoot (i.e., photographed), an image of the background is take in addition to an image of the commodity. In a process for recognizing a commodity, the background image becomes unnecessary noises. Therefore, it is necessary to eliminate the background image to perform the commodity recognition process. However, Patent Literature 1 does not disclose any method for eliminating the background. Therefore, in the technique disclosed in Patent Literature 1, the commodity recognition process is performed by using an image including the background image. Consequently, the accuracy of the commodity recognition deteriorates and hence the recognition rate of commodities could deteriorate.

The present invention has been made to solve the above-described problem and to provide a POS terminal device, a POS system, an image processing method, and a non-transitory computer readable medium storing a program capable of extracting an image of a commodity from an image taken by image pickup means in order to contribute to an improvement in the recognition rate of commodities.

### Solution to Problem

A POS terminal device according to the present invention includes: at least one image pickup means for generating a plurality of two-dimensional images by shooting a commodity from a plurality of viewpoints, each of the plurality of two-dimensional images corresponding to a respective one of the plurality of viewpoints; three-dimensional image generation means for generating a three-dimensional image including an image of the commodity by using the plurality of two-dimensional images generated by the image pickup means; and commodity image extraction means for extracting the image of the commodity by using the three-dimensional image.

Further, a POS system according to the present invention includes a POS terminal device and a management device configured to communicate with the POS terminal device.

Further, an image processing method according to the present invention includes: generating a plurality of two-dimensional images by shooting a commodity from a plurality of viewpoints, each of the plurality of two-dimensional images corresponding to a respective one of the plurality of viewpoints; generating a three-dimensional image including an image of the commodity by using the plurality of generated two-dimensional images; and extracting the image of the commodity by using the three-dimensional image.

Further, a program according to the present invention causes a computer to execute: a step of generating a plurality of two-dimensional images by making at least one image pickup means shoot a commodity from a plurality of viewpoints, each of the plurality of two-dimensional images corresponding to a respective one of the plurality of viewpoints; a step of generating a three-dimensional image including an image of the commodity by using the plurality of generated two-dimensional images; and a step of extracting the image of the commodity by using the three-dimensional image.

### Advantageous Effects of Invention

According to the present invention, it is possible to provide a POS terminal device, a POS system, an image processing method, and a non-transitory computer readable medium storing a program capable of extracting an image of a commodity from an image taken by image pickup means in order to contribute to an improvement in the recognition rate of commodities.

### BRIEF DESCRIPTION OF DRAWINGS

FIG. 1 shows an outline of a POS terminal device according to an exemplary embodiment of the present invention;

FIG. 2 is a side view showing an external appearance of a POS terminal device according to a first exemplary embodiment;

FIG. 3 is a plan view showing an external appearance of the POS terminal device according to the first exemplary embodiment;

FIG. 4 shows a hardware configuration of the POS terminal device according to the first exemplary embodiment;

FIG. 5 is a functional block diagram of the POS terminal device according to the first exemplary embodiment;

FIG. 6 is a flowchart showing processes performed by the POS terminal device according to the first exemplary embodiment;

FIG. 7A is a diagram for explaining a process performed by a commodity image extraction unit;

FIG. 7B is a diagram for explaining a process performed by the commodity image extraction unit;

FIG. 8 shows examples of commodities that have the same shape and package, but have different sizes;

FIG. 9 is a plan view showing an external appearance of a POS terminal device according to a second exemplary embodiment;

FIG. 10 is a functional block diagram of the POS terminal device according to the second exemplary embodiment;

FIG. 11 is a flowchart showing processes performed by the POS terminal device according to the second exemplary embodiment;

FIG. 12 is a plan view showing an external appearance of a POS terminal device according to a third exemplary embodiment;

FIG. 13 is a functional block diagram of the POS terminal device according to the third exemplary embodiment;

FIG. 14 is a flowchart showing processes performed by the POS terminal device according to the third exemplary embodiment;

FIG. 15 shows an example of a two-dimensional image including a left-side mirror image and a right-side mirror image;

FIG. 16 is a plan view showing an external appearance of a POS terminal device according to a fourth exemplary embodiment;

FIG. 17 is a functional block diagram of the POS terminal device according to the fourth exemplary embodiment;

FIG. 18 is a flowchart showing processes performed by the POS terminal device according to the fourth exemplary embodiment;

FIG. 19 is a functional block diagram showing a start control unit of a POS terminal device according to a fifth exemplary embodiment;

FIG. 20 is a flowchart showing processes performed by the start control unit of the POS terminal device according to the fifth exemplary embodiment;

FIG. 21 shows a POS system according to a sixth exemplary embodiment;

FIG. 22 shows a hardware configuration of a management device according to the sixth exemplary embodiment;

FIG. 23 is a functional block diagram of a POS terminal device according to the sixth exemplary embodiment; and

FIG. 24 is a functional block diagram of the management device according to the sixth exemplary embodiment.

### DESCRIPTION OF EMBODIMENTS

### Outline of Exemplary Embodiment According to the Present Invention

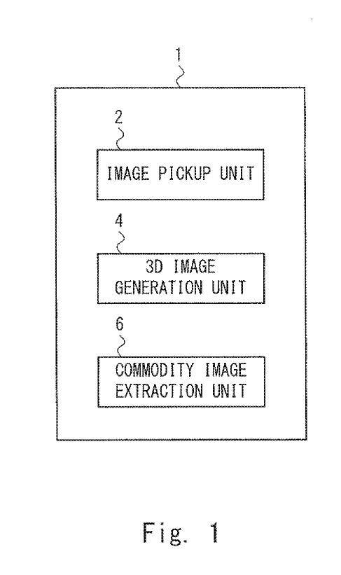

Prior to giving an explanation of exemplary embodiments according to the present invention, an outline of an exemplary embodiment thereof is explained. FIG. 1 shows an outline of a POS terminal device 1 according to an exemplary embodiment of the present invention. As shown in FIG. 1, the POS terminal device 1 includes at least one image pickup unit 2 (pickup means), a three-dimensional image generation unit 4 (three-dimensional image generation means), and a commodity image extraction unit 6 (commodity image extraction means).

The image pickup unit 2 generates a plurality of two-dimensional (hereinafter referred to as “2D”) images by shooting (i.e., photographing) a commodity from a plurality of viewpoints, in which each of the plurality of 2D images corresponds to a respective one of the plurality of viewpoints. The three-dimensional (hereinafter referred to as “3D”) image generation unit 4 generates a 3D image including an image of the commodity by using the plurality of 2D images generated by the image pickup unit 2. The commodity image extraction unit 6 extracts the image of the commodity by using the 3D image. The POS terminal device 1 according to an exemplary embodiment of the present invention makes it possible to extract an image of a commodity from an image taken by the image pickup unit 2 in order to contribute to an improvement in the recognition rate of commodities. Further, a POS system including the above-described POS terminal device 1 and the image processing method for executing the above-described processes also make it possible to extract an image of a commodity from an image taken by the image pickup unit in order to contribute to an improvement in the recognition rate of commodities.

### First Exemplary Embodiment

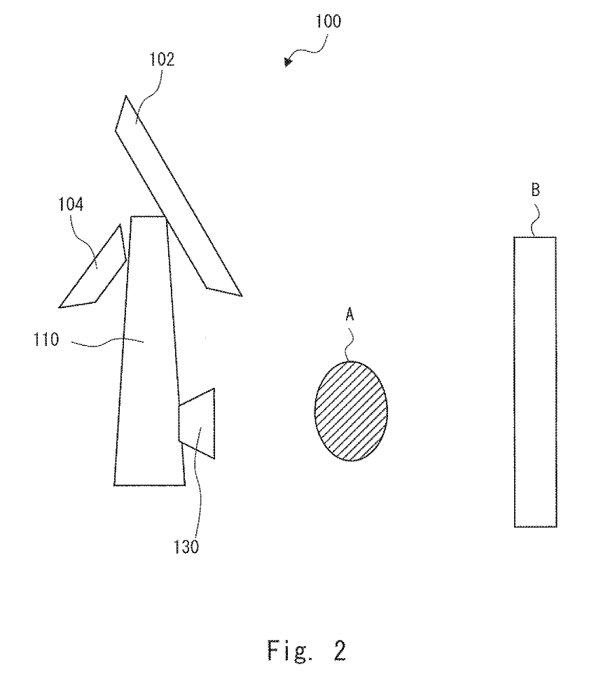

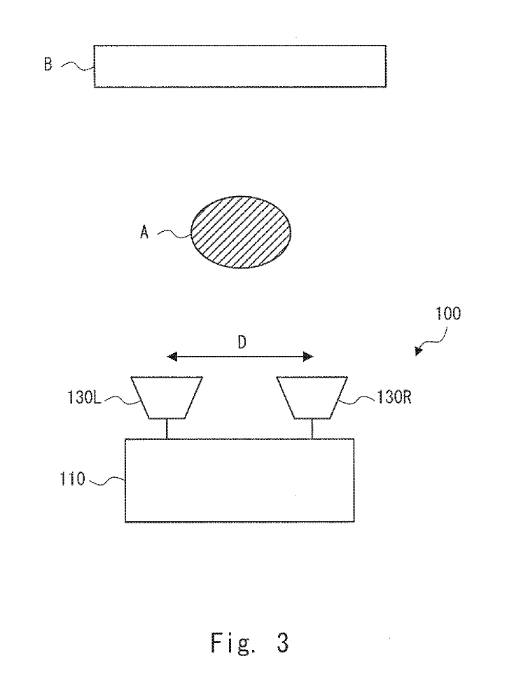

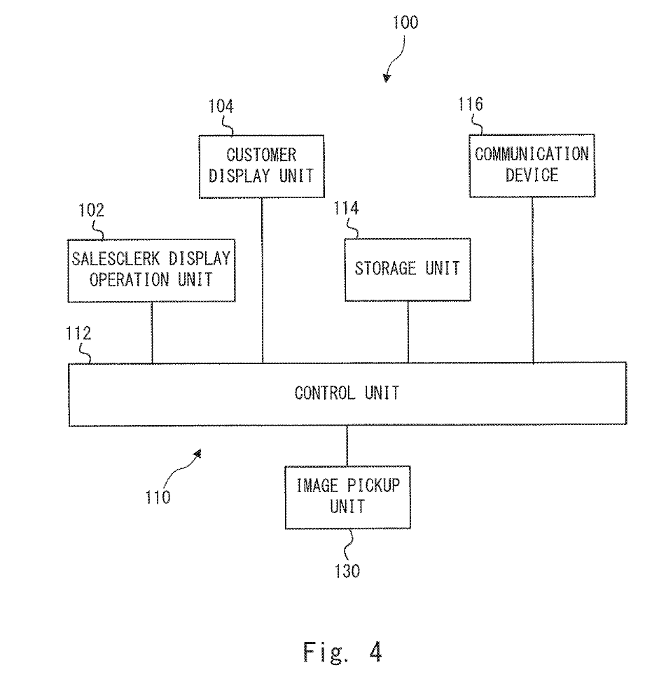

Exemplary embodiments according to the present invention are explained hereinafter with reference to the drawings. FIG. 2 is a side view showing an external appearance of a POS terminal device 100 according to a first exemplary embodiment. Further, FIG. 3 is a plan view showing an external appearance of the POS terminal device 100 according to the first exemplary embodiment. Further, FIG. 4 shows a hardware configuration of the POS terminal device 100 according to the first exemplary embodiment.

The POS terminal device 100 includes a salesclerk display operation unit 102, a customer display unit 104, an information processing device 110, and an image pickup unit 130. The POS terminal device 100 is placed on, for example, a counter (not shown). Further, a customer and a salesclerk stand on the left and right sides, respectively, of the POS terminal device 100 in FIG. 2, and they face each other with the POS terminal device 100 interposed therebetween.

The salesclerk display operation unit 102 is, for example, a touch panel, an LCD (Liquid Crystal Display), a keyboard, or the like. The salesclerk display operation unit 102 displays information necessary for the salesclerk under the control of the information processing device 110 and receives an operation performed by the salesclerk.

The customer display unit 104 is, for example, a touch panel, an LCD, or the like. The customer display unit 104 displays information necessary for the customer under the control of the information processing device 110. Further, the customer display unit 104 may include an input device and receive an operation performed by the customer as required.

The information processing device 110 is, for example, a computer. The information processing device 110 includes, for example, a control unit 112 such as a CPU (Central Processing Unit), a storage unit 114 such as a memory or a hard disk, and a communication device 116. The information processing device 110 controls the operations of the salesclerk display operation unit 102, the customer display unit 104, and the image pickup unit 130. Further, the information processing device 110 performs a necessary process according to an operation received by the salesclerk display operation unit 102. Further, the information processing device 110 performs a necessary process such as image processing according to image information read by the image pickup unit 130. The communication device 116 performs a process necessary for performing communication with a management device, such as a server, connected to the communication device 116 through a network.

The image pickup unit 130 reads (i.e., takes) an image of a commodity A that the salesclerk has received from the customer (i.e., takes a commodity image). In this way, the POS terminal device 100 performs a process for recognizing the commodity. Details of the recognition process are described later. The image pickup unit 130 is, for example, an image pickup device (a camera) such as a CCD (Charge-Coupled Device) and performs a process for reading (i.e., taking) an image of the commodity A. Specifically, the image pickup unit 130 shoots the commodity A and generates a 2D color or monochrome image (a 2D image) including an image of the commodity A. Note that, hereinafter, the term “2D image” also means “image data representing a 2D image” to be processed in information processing. It should be noted that the 2D image generated by the image pickup unit 130 could include a background object B located behind the commodity A as a background.

Further, in the first exemplary embodiment, the image pickup unit 130 incudes, for example, an image pickup unit L 130L and an image pickup unit R 130R, which are two image pickup devices. The image pickup unit L 130L and the image pickup unit R 130R are arranged in a left/right direction with an interval D therebetween. The image pickup unit L 130L shoots the commodity A from a left-side viewpoint and generates a 2D image ImL corresponding to the left-side viewpoint. Similarly, the image pickup unit R 130R shoots the commodity A from a right-side viewpoint and generates a 2D image ImR corresponding to the right-side viewpoint. In this way, the image pickup unit 130 generates a plurality of 2D images each of which corresponds to a respective one of a plurality of viewpoints.

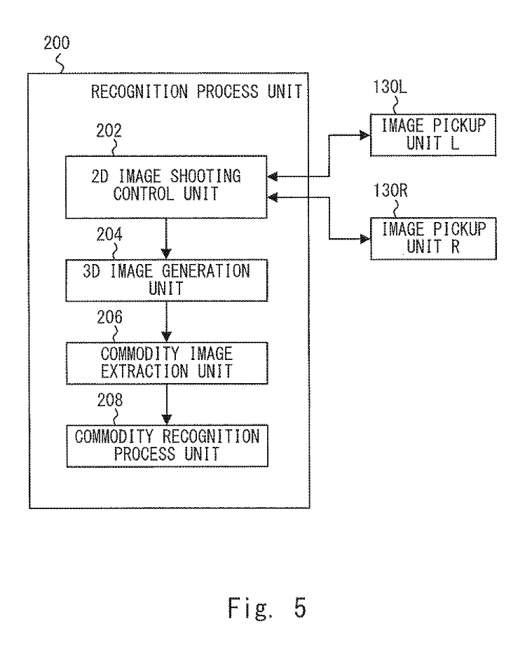

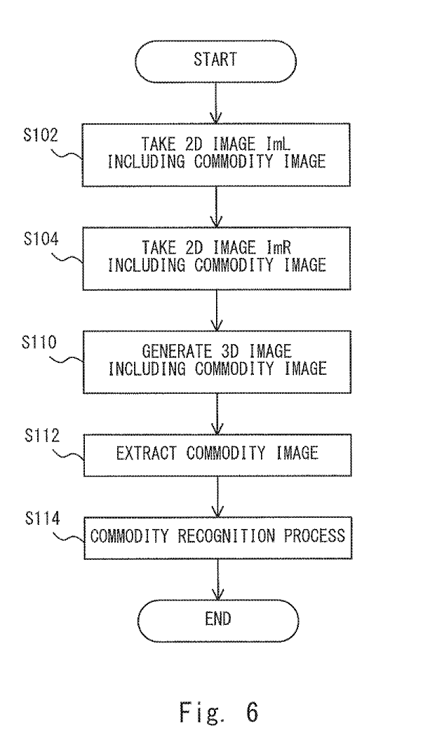

FIG. 5 is a functional block diagram of the POS terminal device 100 according to the first exemplary embodiment. FIG. 6 is a flowchart showing processes performed by the POS terminal device 100 according to the first exemplary embodiment. The POS terminal device 100 according to the first exemplary embodiment includes a recognition process unit 200. The recognition process unit 200 includes a 2D image shooting control unit 202, a 3D image generation unit 204, a commodity image extraction unit 206, and a commodity recognition process unit 208.

Note that the recognition process unit 200 can be implemented by, for example, executing a program under the control of the control unit 112. More specifically, the recognition process unit 200 may be implemented by, for example, executing a program stored in the storage unit 114 under the control of the control unit 112. Further, each component does not necessarily have to be implemented by software by using a program. That is, each component may be implemented by any combination of hardware, firmware, software, and the like. Further, each component in the recognition process unit 200 may be implemented by using, for example, an integrated circuit that can be programed by a user, such as an FPGA (field-programmable gate array) or a microcomputer. In such a case, a program formed from each of the above-described components may be implemented by using this integrated circuit. This similarly applies to a recognition process unit and a start control unit in later-described other exemplary embodiments.

The 2D image shooting control unit 202 makes the image pickup unit L 130L take a 2D image ImL including an image of a commodity from a left-side viewpoint (S102). Specifically, the 2D image shooting control unit 202 controls the image pickup unit L 130L to make the image pickup unit L 130L shoot a commodity pointed toward the image pickup unit 130. Then, the 2D image shooting control unit 202 acquires a 2D image ImL generated by the image pickup unit L 130L and outputs the acquired 2D image ImL to the 3D image generation unit 204. Note that this 2D image could include an image of a background object B (a background image) in addition to the commodity image.

The 2D image shooting control unit 202 makes the image pickup unit R 130R take a 2D image ImR including an image of a commodity from a right-side viewpoint (S104). Specifically, the 2D image shooting control unit 202 controls the image pickup unit R 130R to make the image pickup unit R 130R shoot a commodity pointed toward the image pickup unit 130. Then, the 2D image shooting control unit 202 acquires a 2D image ImR generated by the image pickup unit R 130R and outputs the acquired 2D image ImR to the 3D image generation unit 204. Note that this 2D image could include an image of a background object B (a background image) in addition to the commodity image.

The 3D image generation unit 204 generates a 3D image by using the 2D images ImL and ImR (S110). Then, the 3D image generation unit 204 outputs the generated 3D image to the commodity image extraction unit 206. Specifically, the 3D image generation unit 204 calculates a distance (a depth) to each point of the commodity A and the background object B, which have been in each of the 2D images ImL and ImR. Then, the 3D image generation unit 204 generates a 3D image that is composed as a set of pixels corresponding to the respective points in the commodity A and the background object B. Note that, hereinafter, the term “3D image” also means “image data representing the 3D image” that is processed in information processing.

Note that pixels in the 3D image include color information of respective points in the commodity A and the background object B, and distance information indicating distances to those respective points. For example, when a point P in an object (the commodity A or the background object B) to be shot corresponds to a pixel (X1, Y1) of the 3D image, the pixel (X1, Y1) includes color information of that point P and distance information indicating a distance from the image pickup unit 130 to that point P. Note that the color information includes a brightness value in each of RGB (Red-Green-Blue), a grayscale value, a color tone value, or the like.

More specifically, the 3D image generation unit 204 calculates a distance to each point in the commodity A and the background object B by using, for example, a parallax between the 2D images ImL and ImR. The parallax is an amount of a deviation of an object between two 2D images and can be calculated by block matching or the like. A relation between a distance Z to a shot object and a parallax d thereof is expressed as “d=f×D/Z”. In the expression, f is the focal length of the image pickup unit L 130L and the image pickup unit R 130R. There is a correlation between the distance Z and the parallax d and hence the parallax can be used as distance information (depth information) in this exemplary embodiment. Further, the distance Z and the parallax d have such a relation of the monotonic decrease, and hence parallax information can be used as distance information (depth information) based on this relation.

The commodity image extraction unit 206 distinguishes (i.e., determines) an area whose distance from the image pickup unit 130 in the 3D image is equal to or shorter than a threshold Th1 (a first threshold) and extracts an image area corresponding to that area from the 3D image as a commodity image (S112). Further, the commodity image extraction unit 206 outputs the extracted commodity image to the commodity recognition process unit 208.

Specifically, the commodity image extraction unit 206 compares, for each of the pixels constituting the 3D image, a distance indicated by distance information included in that pixel with the threshold Th1. Then, the commodity image extraction unit 206 extracts pixels including distance information indicating distances equal to or shorter than the threshold Th1. In this way, the commodity image extraction unit 206 extracts a set of extracted pixels as an image area corresponding to the commodity image.

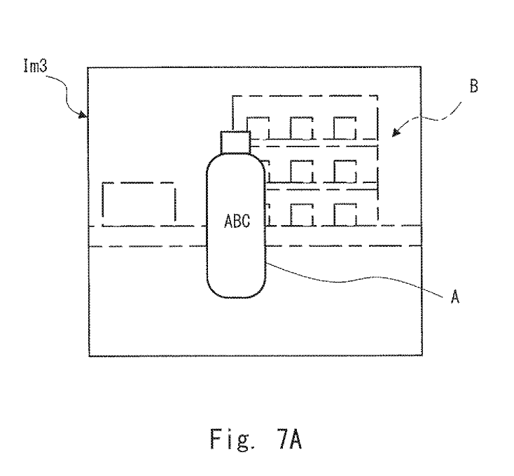

FIGS. 7A and 7B are diagrams for explaining a process performed by the commodity image extraction unit 206. FIG. 7A shows a 3D image Im3, including a commodity image, generated by the 3D image generation unit 204. The 3D image Im3 includes a commodity image A (indicated by solid lines) and a background image B (indicated by dashed lines). In the example shown in FIGS. 7A and 7B, the commodity A corresponding to the commodity image A is a PET-bottled drink. Further, the background object B corresponding to the background image B is a shelf that is disposed so that it faces the POS terminal device 100. The commodity A corresponding to the commodity image A is located in a place whose distance from the image pickup unit 130 is equal to or shorter than the threshold Th1. In contrast to this, the background object B corresponding to the background image B is located in a place whose distance from the image pickup unit 130 is longer than the threshold Th1.

The commodity image extraction unit 206 extracts, in the 3D image Im3, an image area, which is a set of pixels including distance information indicating distances equal to or shorter than the threshold Th1, from the 3D image Im3. Note that as described above, the commodity A corresponding to the commodity image A is located in the place whose distance from the image pickup unit 130 is equal to or shorter than the threshold Th1. As a result, a commodity image E shown in FIG. 7B, for example, is extracted. Note that the commodity image E does not include the background image. That is, the commodity image extraction unit 206 eliminates the background image B from the 3D image Im3.

The commodity recognition process unit 208 (FIG. 5) performs a commodity recognition process by using the commodity image extracted by the commodity image extraction unit 206 (S114). The POS terminal device 100 performs a settlement process (or a payment process) and the like for the commodity by using commodity information obtained by the commodity recognition process performed by the commodity recognition process unit 208. Note that the commodity information is information for identifying the commodity and may include, for example, the name of the commodity, the name of the manufacturer of the commodity, the price of the commodity, and so on. Further, the commodity information may include the size (volume) of the commodity.

Regarding the commodity recognition process, specifically speaking, for example, the commodity recognition process unit 208 associates names of commodities with information about those commodities (reference commodity information) and stores them in advance. The commodity recognition process unit 208 performs pattern matching between the extracted commodity image and the pre-stored reference commodity information. Examples of the reference commodity information are shown hereinafter.

For example, the reference commodity information may be an image that is used as a reference image of a commodity (reference commodity image). In this case, the commodity recognition process unit 208 compares the extracted commodity image with the reference commodity image. Then, when the similarity between them meets a permissible value, the commodity recognition process unit 208 associates the commodity with the name of a commodity corresponding to the reference commodity image.

Further, for example, the reference commodity information may be data representing a reference feature(s) of a commodity (commodity feature data). For example, the commodity feature data may include at least one of information indicating the shape of the commodity, information indicating the color of the commodity, information indicating the texture (such as a luster) of the commodity, and information indicating text information and a pattern attached to the package of the commodity. In this case, the commodity recognition process unit 208 extracts a feature(s) of the extracted commodity image from the extracted commodity image. Then, the commodity recognition process unit 208 compares the extracted feature of the image with the commodity feature data. Then, when the similarity between them meets a permissible value, the commodity recognition process unit 208 associates the commodity with the name of a commodity corresponding to the commodity feature data. Further, the commodity recognition process unit 208 may recognize the name of a commodity by reading text information attached to the package of the commodity by using an OCR (Optical Character Reader).

Note that the background has been eliminated in the commodity image extracted by the commodity image extraction unit 206. Therefore, when the commodity recognition process unit 208 performs the process for recognizing the commodity, the commodity recognition process unit 208 does not need to eliminate the background to perform the recognizing process. When a 3D image (or a 2D image) includes a background image in addition to a commodity image, it is necessary, first of all, to recognize where the commodity image is located in the 3D image in the commodity recognition process. In particular, in the case where various customers use the POS terminal device 100 such as in the case of a self-checkout counter, which part of the image pickup unit 130 the customer points the commodity toward differs from one customer to another. In this process for recognizing where the commodity image is located, it is necessary, for example, to compare the reference commodity information with each and every one of the images included in the 3D image. As a result, the processing time significantly increases.

In contrast to this, in this exemplary embodiment, since the commodity image itself is used, there is no need to recognize where the commodity image is located in the 3D image. Therefore, the POS terminal device 100 according to this exemplary embodiment can improve the processing speed of the commodity recognition process. In other words, the POS terminal device 100 according to this exemplary embodiment can reduce the load on the resources in the commodity recognition process. Further, the amount of data of the commodity image is reduced in comparison with the amount of data of the 3D image by an amount corresponding to the elimination of the background. Therefore, since the amount of data to be processed can be reduced, the resources and the load can be reduced. This makes it possible to use a device equipped with a few resources such as a tablet terminal as the POS terminal device 100 according to this exemplary embodiment. Note that the term “resources” includes network resources in addition to the hardware resources of the POS terminal device 100 itself. That is, the network load can also be reduced in this exemplary embodiment.

Further, when a background image is included in a commodity image, the background image affects the commodity recognition process. As a result, the recognition rate in the commodity recognition process deteriorates. In contrast to this, since the background is eliminated from the commodity image extracted by the commodity image extraction unit 206, the recognition rate can be improved.

Further, there are cases where an image of a body of a salesclerk or the like who is holding a commodity is included in a 2D image including an image of the commodity taken by the image pickup unit 130. In such a case, if a method in which a difference from a background image taken in advance is used in order to extract a commodity image is used, the body of the salesclerk or the like is also recognized as a difference. As a result, the image of the body of the salesclerk or the like is also included in the extracted commodity image and the image of the body of the salesclerk or the like becomes noises. Consequently, the recognition rate of commodities deteriorates.

It should be noted that when a person points a commodity toward the image pickup unit 130, the person usually extends his/her arm to point the commodity toward the image pickup unit 130. Therefore, the body of the salesclerk or the like is usually away from the image pickup unit 130. Therefore, in this exemplary embodiment, the commodity image extraction unit 206 can eliminate the image of the body of the salesclerk or the like. As a result, the commodity recognition process unit 208 can perform the process for recognizing the commodity by using the commodity image alone without taking account of the image of the body of the salesclerk or the like. Consequently, the POS terminal device 100 according to this exemplary embodiment can improve the recognition rate of commodities even further.

Further, in the method in which a difference from a background image taken in advance is used, when the color tone of the background differs from that of the background image taken in advance due to external light (e.g., due to evening sunlight), the background could also be recognized as a difference when a commodity image is extracted. As a result, the background image is also included in the commodity image and hence the background image becomes noises. Consequently, the recognition rate of commodities deteriorates.

Note that the background object B is away from the image pickup unit 130. Therefore, in this exemplary embodiment, the commodity image extraction unit 206 can reliably eliminate the background irrespective of the change in the color of the background. Consequently, the POS terminal device 100 according to this exemplary embodiment can improve the recognition rate of commodities even further.

Further, the extracted commodity image is a part of the 3D image. Therefore, the extracted commodity image includes the distance to each point in the commodity A, i.e., the distance information indicating the depth. Therefore, the commodity recognition process unit 208 can recognize the projection/depression shape of the surface of the commodity A. Consequently, the commodity recognition process unit 208 can perform a process for recognizing a commodity A by using the recognized projection/depression shape of the surface of the commodity A.

For example, in the example shown in FIGS. 7A and 7B, the container of the PET-bottled drink, which is the commodity A, has a roughly cylindrical shape. Therefore, in the commodity image E corresponding to the commodity A, the distance to the commodity A increases from the central part e1 of the commodity image E to both ends e2 thereof. In other words, in the commodity image E, a distance indicated by the distance information of a pixel corresponding to the central part of the commodity image E is shorter than the distance indicated by the distance information of a pixel corresponding to either end thereof. Therefore, the commodity recognition process unit 208 can recognize that the central part e1 is projecting and both ends e2 are depressed in the commodity image E. Consequently, since commodity feature data includes data indicating a projection/depression shape corresponding to distance information, it is possible to perform a commodity recognition process using the projection/depression shape.

Therefore, the POS terminal device 100 according to this exemplary embodiment can perform a process for recognizing a commodity while distinguishing between, for example, a picture attached to a package of the commodity (e.g., a picture of an apple) and an actual object (e.g., an actual apple). That is, the POS terminal device 100 according to this exemplary embodiment recognizes a picture of an apple as a planar object having no projection/depression, and recognizes an actual apple as a three-dimensional object having a projection/depression. Further, the POS terminal device 100 according to this exemplary embodiment can perform a process for recognizing a commodity while distinguishing between, for example, commodities that have external shapes and colors similar to each other but have projection/depression shapes different from each other, such as apples and tomatoes. Therefore, the POS terminal device 100 according to this exemplary embodiment can improve the recognition rate of commodities even further.

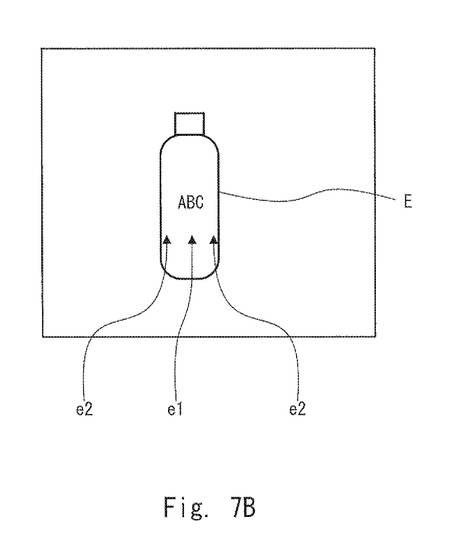

Further, there are commodities that have the same shapes and packages, but have different sizes. For example, as shown in FIG. 8, there are PET-bottled drinks that contain the same contents, but have different sizes (volumes) on the market. In general, the prices of such commodities change according to the size. In such cases, if the commodity recognition process is performed by using only the commodity image, the size of the commodity cannot be recognized. Therefore, a salesclerk or the like needs to manually enter the price or volume of the commodity in order to make the payment with an appropriate price.

In contrast to this, as described above, the POS terminal device 100 according to this exemplary embodiment can calculate a distance to a commodity in the 3D image generation unit 204. Even when the size of an actual commodity is unchanged, the size of the commodity image in a 3D image becomes smaller as the distance thereto (the depth) increases and becomes larger as the distance thereto (the depth) decreases. That is, it is possible to geometrically recognize the size of an actual commodity from the size of the commodity image in a 3D image and the distance to the commodity.

Therefore, the commodity recognition process unit 208 may recognize the size of a commodity by acquiring distance information, indicating a distance to the commodity, included in the extracted commodity image and thereby measuring the size of the commodity image. Specifically, the commodity recognition process unit 208 calculates the distance to the commodity from distance information of each of the pixels constituting the commodity image. For the calculation method, for example, a distance indicated by a pixel corresponding to an edge of the commodity image may be used as the distance to the commodity, or an average of distances indicated by respective pixels within an area of the commodity image may be used as the distance to the commodity.

Further, the commodity recognition process unit 208 measures the size of the commodity image in the 3D image. As the size of the commodity image, for example, a vertical size and a horizontal size are measured. Then, the commodity recognition process unit 208 calculates the size of the actual commodity from the size of the commodity image and the distance to the commodity. Note that reference commodity information used as a reference in the commodity recognition process may include the size and the volume of the commodity. Therefore, the commodity recognition process unit 208 can recognize, for example, the name and the volume of the commodity (in the example shown in FIG. 8, “Commodity name: ABC, Volume: 500 ml”) and so on. In this way, the POS terminal device 100 according to this exemplary embodiment can improve the recognition rate of commodities even further.

Note that examples of the means for measuring a distance that is different from this exemplary embodiment include a 3D camera equipped with a distance sensor (a depth sensor). The 3D camera further includes an image pickup unit that generates a 2D image as in the case of this exemplary embodiment in addition to the distance sensor. The distance sensor includes an emitting unit that emits infrared light and a light receiving unit that receives infrared light reflected from an object. The distance sensor measures a distance to each point in the object by using, for example, a TOF (Time Of Flight) method. Further, the distance sensor generates a distance image, which is a set of pixels indicating distances to respective points of the object. The emitting unit, the light receiving unit, and the image pickup unit are arranged close to each other.

Further, the 3D camera associates a 2D image generated by the image pickup unit with the distance image. Specifically, the 3D camera associates points of an object corresponding to respective pixels in the 2D image with points of the object corresponding to respective pixels in the distance image. For this association, the 3D camera performs a process in which each of the pixel positions in the 2D image is aligned with a respective one of the pixel points in the distance image based on the distance between the image pickup unit and the distance sensor, and the viewing angle of each of the image pickup unit and the distance sensor. It should be noted that it is not easy to accurately carry out this aligning process. Therefore, it is not easy to associate the 2D image with the distance image.

In contrast to this, the POS terminal device 100 according to this exemplary embodiment is configured so that an image pickup device that generates a 2D image is used as an image pickup unit and a 3D image is generated by using a plurality of 2D images taken from a plurality of viewpoints. That is, this exemplary embodiment does not require the distance sensor. Therefore, there is no need to perform the above-described aligning process. Consequently, this exemplary embodiment can make the process for generating a 3D image easier.

### (Second Exemplary Embodiment

Next, a second exemplary embodiment is explained. The second exemplary embodiment differs from the first exemplary embodiment in that the second exemplary embodiment includes only one image pickup unit. Note that the same symbols as those in the first exemplary embodiment are assigned to components/structures substantially similar to those in the first exemplary embodiment and thus their explanations are omitted (this is also applicable to the later-described other exemplary embodiments).

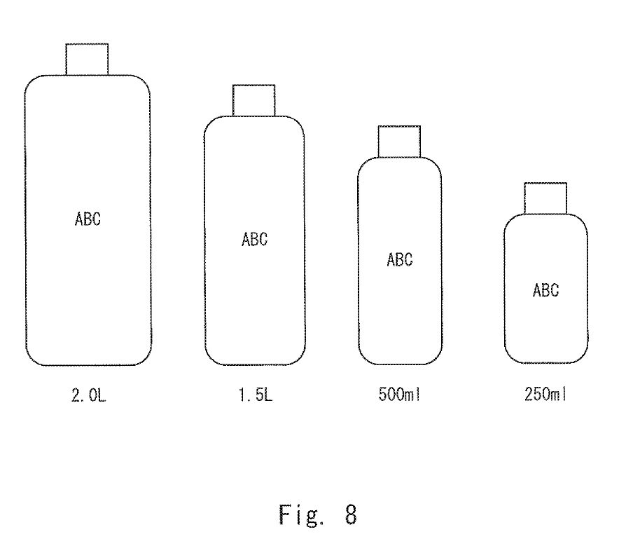

FIG. 9 is a plan view showing an external appearance of a POS terminal device 100 according to the second exemplary embodiment. The POS terminal device 100 according to the second exemplary embodiment includes only one image pickup unit 130. The image pickup unit 130 is configured so that the image pickup unit 130 moves, for example, in the horizontal direction under the control of a control unit 112 of the information processing device 110. Note that the hardware configuration of the POS terminal device 100 according to the second exemplary embodiment is substantially identical to that of the POS terminal device 100 according to the first exemplary embodiment except for the above-described difference.

For example, the image pickup unit 130 moves from a left-side position L to a right-side position R, which is an interval D away from the left-side position in the horizontal direction. Note that the image pickup unit 130 has a function similar to that of the image pickup unit 130 according to the second exemplary embodiment. That is, the image pickup unit 130 shoots a commodity A from a left-side viewpoint in the left-side position L and generates a 2D image ImL corresponding to the left-side viewpoint. Similarly, the image pickup unit 130 shoots the commodity A from a right-side viewpoint in the right-side position R and generates a 2D image ImR corresponding to the right-side viewpoint. In this way, the image pickup unit 130 generates a plurality of 2D images each of which corresponds to a respective one of a plurality of viewpoints.

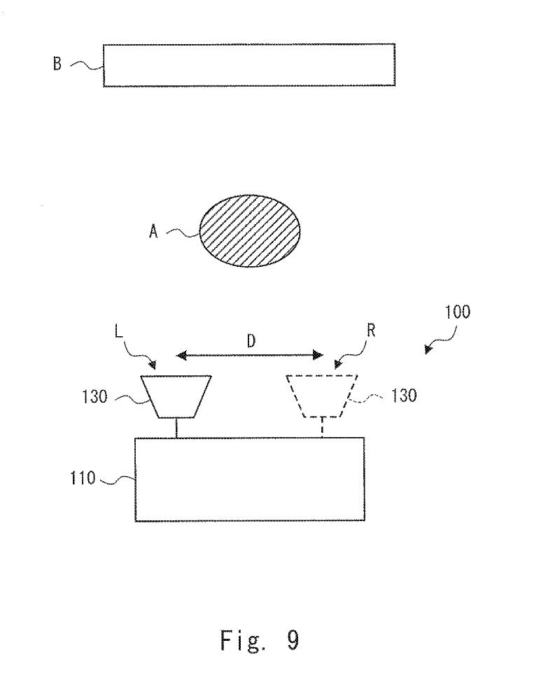

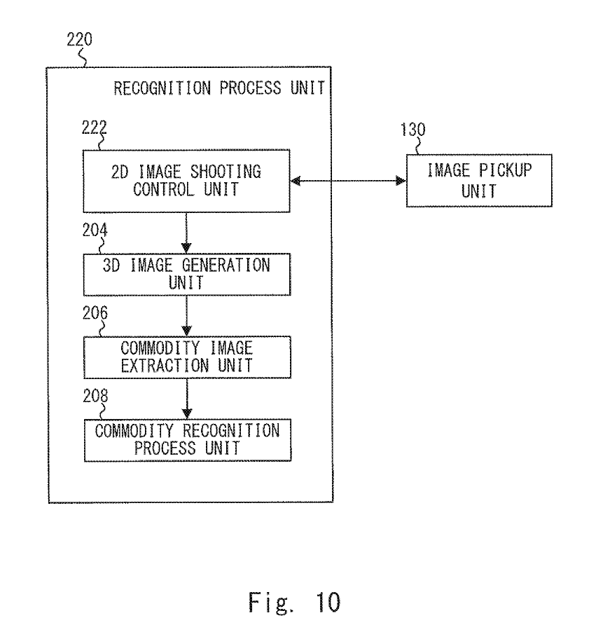

FIG. 10 is a functional block diagram of the POS terminal device 100 according to the second exemplary embodiment. Further, FIG. 11 is a flowchart showing processes performed by the POS terminal device 100 according to the second exemplary embodiment. The POS terminal device 100 according to the second exemplary embodiment includes a recognition process unit 220. The recognition process unit 220 includes a 2D image shooting control unit 222, a 3D image generation unit 204, a commodity image extraction unit 206, and a commodity recognition process unit 208.

The 2D image shooting control unit 222 makes the image pickup unit 130 take a 2D image ImL including a commodity image from a left-side viewpoint (S202). Specifically, the 2D image shooting control unit 222 positions the image pickup unit 130 in a left-side position L. The 2D image shooting control unit 222 controls the image pickup unit 130 to make the image pickup unit 130 shoots a commodity pointed toward the image pickup unit 130 from a left-side viewpoint. Then, the 2D image shooting control unit 222 acquires a 2D image ImL generated by the image pickup unit 130 and outputs the acquired 2D image ImL to the 3D image generation unit 204. Note that this 2D image could include an image of a background object B (a background image) in addition to the commodity image.

The 2D image shooting control unit 222 moves the image pickup unit 130 from the left-side position L to a right-side position R (S204). Then, the 2D image shooting control unit 222 makes the image pickup unit 130 take a 2D image ImR including a commodity image from a right-side viewpoint (S206). Specifically, the 2D image shooting control unit 222 controls the image pickup unit 130 to make the image pickup unit 130 shoots a commodity pointed toward the image pickup unit 130 from a right-side viewpoint. Then, the 2D image shooting control unit 222 acquires a 2D image ImR generated by the image pickup unit 130 and outputs the acquired 2D image ImR to the 3D image generation unit 204. Note that this 2D image could include an image of a background object B (a background image) in addition to the commodity image.

Similarly to the process in the step S110, the 3D image generation unit 204 generates a 3D image by using the 2D images ImL and ImR (S210). The 2D image ImL is taken from the left-side viewpoint. Further, the 2D image ImR is taken from the right-side viewpoint. Therefore, there is a parallax between the 2D images ImL and ImR. Accordingly, similarly to the process in the step S110, the 3D image generation unit 204 can calculate a parallax d. Further, the 3D image generation unit 204 can calculate a distance Z from an interval D between the left-side position L and the right-side position R, and the parallax d by using a relational expression “d=f×D/Z”.

Similarly to the process in the step S112, the commodity image extraction unit 206 distinguishes (i.e., determines) an area whose distance from the image pickup unit 130 in the 3D image is equal to or shorter than a threshold Th1 (a first threshold) and extracts an image area corresponding to that area from the 3D image as a commodity image (S212). Further, similarly to the process in the step S114, the commodity recognition process unit 208 performs a commodity recognition process by using the commodity image extracted by the commodity image extraction unit 206 (S214).

As explained above, similarly to the POS terminal device 100 according to the first exemplary embodiment, the POS terminal device 100 according to the second exemplary embodiment performs a process for recognizing a commodity by using a 3D image including a commodity image. Therefore, similarly to the first exemplary embodiment, the POS terminal device 100 according to the second exemplary embodiment can improve the recognition rate of commodities even further. Further, since the distance sensor is not used, a 3D image can be generated without performing a complicated process such as an aligning process which is necessary when the distance sensor is used.

Further, the POS terminal device 100 according to the second exemplary embodiment is configured so that the POS terminal device 100 generates a 3D image by using only one image pickup unit 130. Therefore, in comparison to the first exemplary embodiment, the number of image pickup units 130 can be reduced.

### Third Exemplary Embodiment

Next, a third exemplary embodiment is explained. The third exemplary embodiment differs from the first exemplary embodiment in that the third exemplary embodiment includes only one image pickup unit. Further, the third exemplary embodiment differs from the second exemplary embodiment in that the image pickup unit is not moved in the third exemplary embodiment.

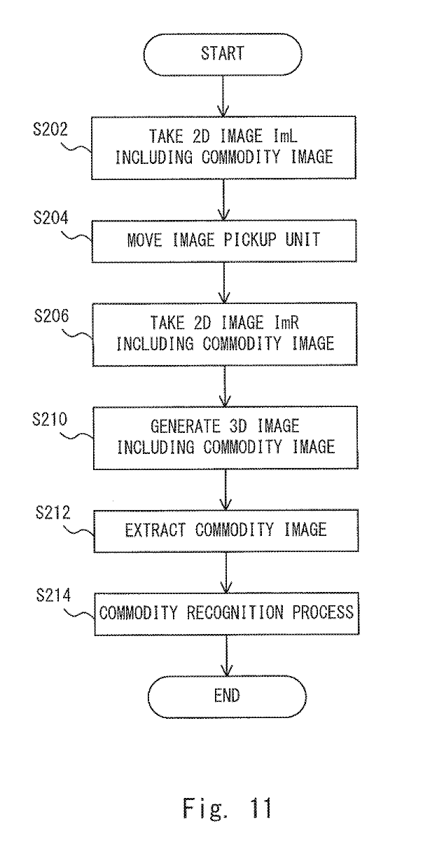

FIG. 12 is a plan view showing an external appearance of a POS terminal device 100 according to the third exemplary embodiment. The POS terminal device 100 according to the third exemplary embodiment includes only one image pickup unit 130. Further, the POS terminal device 100 according to the third exemplary embodiment includes an optical unit 140. The optical unit 140 is disposed in front of the image pickup unit 130. Note that the hardware configuration of the POS terminal device 100 according to the third exemplary embodiment is substantially identical to that of the POS terminal device 100 according to the above-described exemplary embodiment except for the above-described difference.

The optical unit 140 is a component that is used to allow the image pickup unit 130 to shoot a commodity from either of left and right viewpoints. The optical unit 140 includes left-side mirrors 142L and 144L, and right-side mirrors 142R and 144R. The left-side mirrors 142L and 144L are arranged so that their mirror surfaces face each other. Similarly, the right-side mirrors 142R and 144R are arranged so that their mirror surfaces face each other.

The left-side mirror 142L reflects light coming from a commodity A (and a background object B) to the left. The left-side mirror 144L reflects the reflected light from the left-side mirror 142L. The image pickup unit 130 receives the light, which comes from the commodity A (and the background object B) and is reflected on the left-side mirrors 142L and 144L, on the left side of its image pickup device.

The right-side mirror 142R reflects light coming from the commodity A (and the background object B) to the right. The right-side mirror 144R reflects the reflected light from the right-side mirror 142R. The image pickup unit 130 receives the light, which comes from the commodity A (and the background object B) and is reflected on the right-side mirrors 142R and 144R, on the right side of its image pickup device.

In this way, the image pickup unit 130 generates a 2D image including a mirror image ML of the commodity A (and the background object B) that is viewed from a left-side viewpoint and reflected on the left-side mirror 144L, and a mirror image MR of the commodity A (and the background object B) that is viewed from a right-side viewpoint and reflected on the right-side mirror 144R. The mirror image ML is formed on the left side in the 2D image and the mirror image MR is formed on the right side in the 2D image. That is, the image pickup unit 130 shoots the commodity A from a plurality of viewpoints, i.e., from the left and right viewpoints and thereby generates a plurality of 2D images (i.e., mirror images ML and MR) each of which corresponds to a respective one of the plurality of viewpoints.

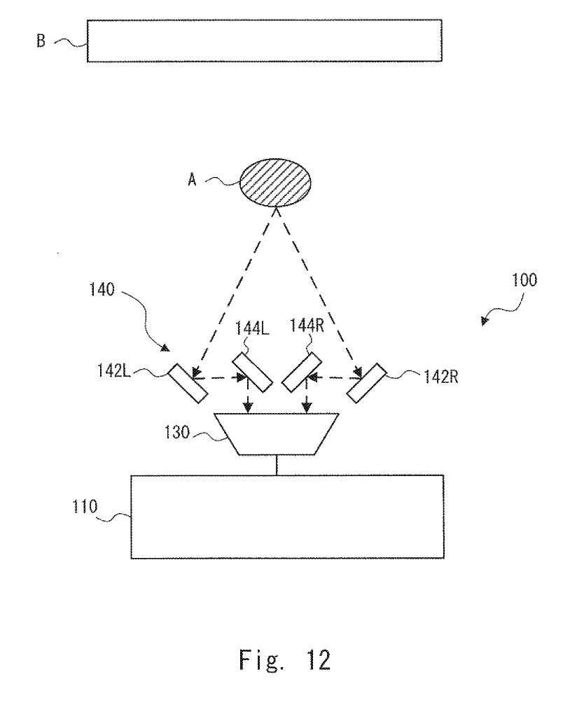

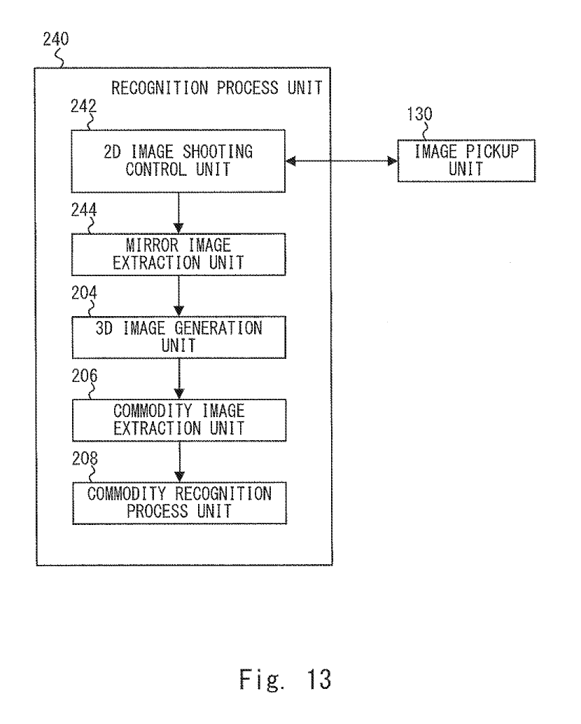

FIG. 13 is a functional block diagram of the POS terminal device 100 according to the third exemplary embodiment. Further, FIG. 14 is a flowchart showing processes performed by the POS terminal device 100 according to the third exemplary embodiment. The POS terminal device 100 according to the third exemplary embodiment includes a recognition process unit 240. The recognition process unit 240 includes a 2D image shooting control unit 242, a mirror image extraction unit 244, a 3D image generation unit 204, a commodity image extraction unit 206, and a commodity recognition process unit 208.

The 2D image shooting control unit 242 makes the image pickup unit 130 take a 2D image Im2 including mirror images ML and MR of a commodity (S302). The 2D image shooting control unit 242 controls the image pickup unit 130 to make the image pickup unit 130 shoot the mirror surfaces of the left-side mirror 144L and the right-side mirror 144R. As a result, as described above, the 2D image Im2 taken by the image pickup unit 130 includes the mirror image MR of the commodity A viewed from the left-side viewpoint and the mirror image ML of the commodity A viewed from the right-side viewpoint. Then, the 2D image shooting control unit 242 acquires the 2D image Im2 generated by the image pickup unit 130 and outputs the acquired 2D image Im2 to the mirror image extraction unit 244.

The mirror image extraction unit 244 extracts the mirror images ML and MR from the 2D image Im2 (S304). Then, the mirror image extraction unit 244 outputs the extracted mirror images ML and MR to the 3D image generation unit 204. As a result, the 3D image generation unit 204 acquires the mirror image ML, which is a 2D image taken from the left-side viewpoint, and the mirror image MR, which is a 2D image taken from the right-side viewpoint. Note that the each of the mirror images ML and MR could include a background image in addition to the commodity image.

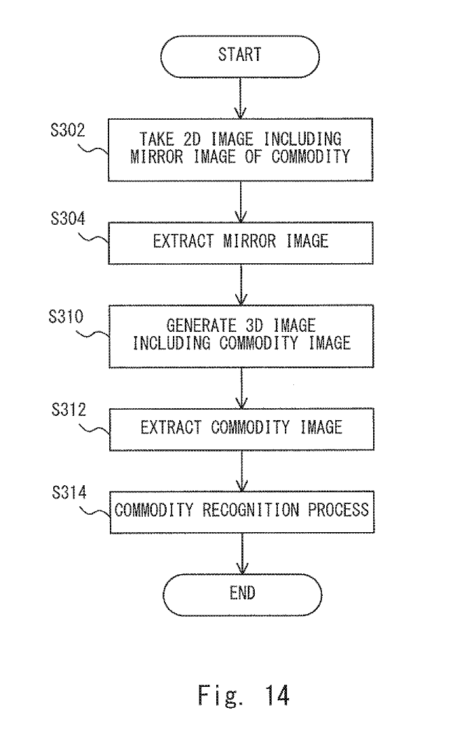

FIG. 15 shows an example of a 2D image Im2 including a left-side mirror image ML and a right-side mirror image MR. The mirror image ML is positioned in a left-side area SL of the 2D image Im2. Meanwhile, the mirror image MR is positioned in a right-side area SR of the 2D image Im2. Each of the mirror images ML and MR includes a commodity A (indicated by solid lines) and a background image B (indicated by dashed lines).

Note that by fixing the positional relation between the image pickup unit 130 and the optical unit 140, the area SL of the mirror image ML and the area SR of the mirror image MR can be fixed in the 2D image Im2 taken by the image pickup unit 130. As a result, the mirror image extraction unit 244 can recognize the mirror images ML and MR in the 2D image Im2. Therefore, the mirror image extraction unit 244 can extract the mirror images ML and MR from the 2D image Im2.

Similarly to the process in the step S110, the 3D image generation unit 204 generates a 3D image by using the mirror images ML and MR (S310). The mirror image ML is taken from the left-side viewpoint. Further, the mirror image MR is taken from the right-side viewpoint. Therefore, there is a parallax between the mirror images ML and MR. Accordingly, similarly to the process in the step S110, the 3D image generation unit 204 can calculate a parallax d. Further, letting D represent an interval between the left-side mirror and the right-side mirror in the optical unit 140, the 3D image generation unit 204 can calculate a distance Z from the parallax d by using a relational expression “d=f×D/Z”.

Further, similarly to the process in the step S112, the commodity image extraction unit 206 distinguishes (i.e., determines) an area whose distance from the image pickup unit 130 in the 3D image is equal to or shorter than a threshold Th1 (a first threshold) and extracts an image area corresponding to that area from the 3D image as a commodity image (S312). Further, similarly to the process in the step S114, the commodity recognition process unit 208 performs a commodity recognition process by using the commodity image extracted by the commodity image extraction unit 206 (S314).

As explained above, similarly to the POS terminal device 100 according to the first exemplary embodiment, the POS terminal device 100 according to the third exemplary embodiment performs a process for recognizing a commodity by using a 3D image including a commodity image. Therefore, similarly to the first exemplary embodiment, the POS terminal device 100 according to the third exemplary embodiment can improve the recognition rate of commodities even further. Further, since the distance sensor is not used, a 3D image can be generated without performing a complicated process such as an aligning process which is necessary when the distance sensor is used.

Further, the POS terminal device 100 according to the third exemplary embodiment is configured so that the POS terminal device 100 generates a 3D image by using only one image pickup unit 130. Therefore, in comparison to the first exemplary embodiment, the number of image pickup units 130 can be reduced. Further, the POS terminal device 100 according to the third exemplary embodiment is configured so that the POS terminal device 100 generates a 3D image without moving the image pickup unit 130 to the left/right. Therefore, in comparison to the second exemplary embodiment, the structure can be simplified.

### Fourth Exemplary Embodiment

Next, a fourth exemplary embodiment is explained. The fourth exemplary embodiment differs from the first exemplary embodiment in that the fourth exemplary embodiment includes only one image pickup unit. Further, the fourth exemplary embodiment differs from the second exemplary embodiment in that the image pickup unit is not moved in the fourth exemplary embodiment. Further, the fourth exemplary embodiment differs from the third exemplary embodiment in that the optical unit is not provided in the fourth exemplary embodiment.

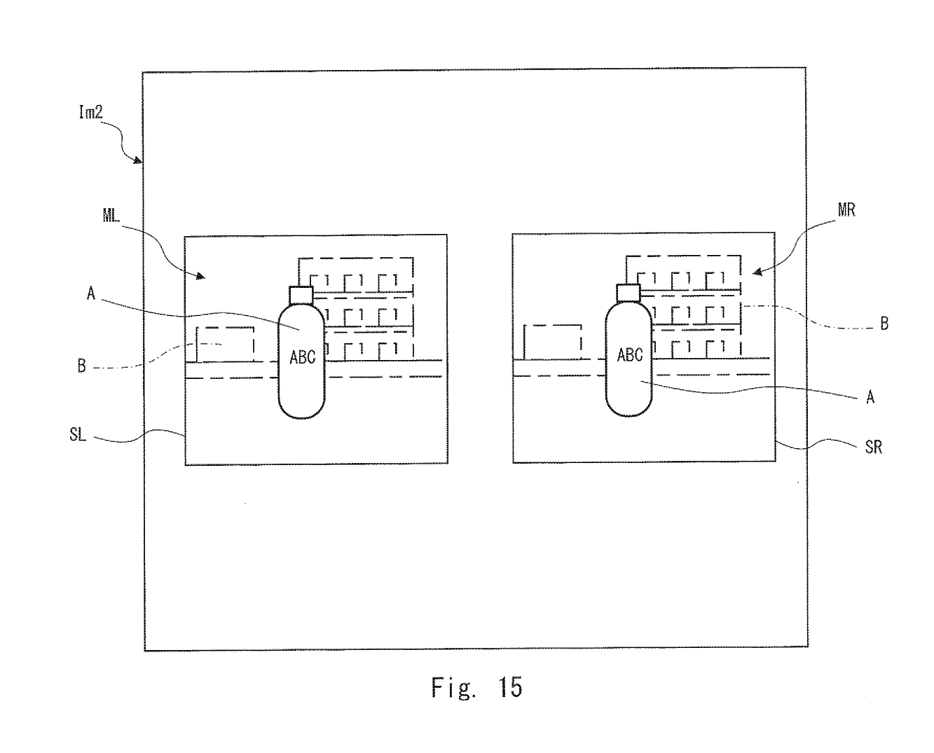

FIG. 16 is a plan view showing an external appearance of a POS terminal device 100 according to the fourth exemplary embodiment. The POS terminal device 100 according to the fourth exemplary embodiment includes only one image pickup unit 130. This image pickup unit 130 takes a 2D image of a commodity A at a plurality of timings. For example, the image pickup unit 130 takes a 2D moving image (i.e., a moving picture) when the commodity A is moved by a hand or the like. Note that the hardware configuration of the POS terminal device 100 according to the third exemplary embodiment is substantially identical to that of the POS terminal device 100 according to the above-described exemplary embodiment except for the above-described difference.

The image pickup unit 130 takes a 2D moving image (a 2D moving image) when the commodity A is moved to the left or right. Note that the 2D moving image could be composed of a plurality of still images (frames) each of which includes a commodity image. These plurality of still images are obtained by shooting (i.e., photographing) the commodity A from a various viewpoints. Therefore, the image pickup unit 130 shoots the commodity A from a plurality of viewpoints and thereby generates a plurality of 2D images (still images) each of which corresponds to a respective one of the plurality of viewpoints.

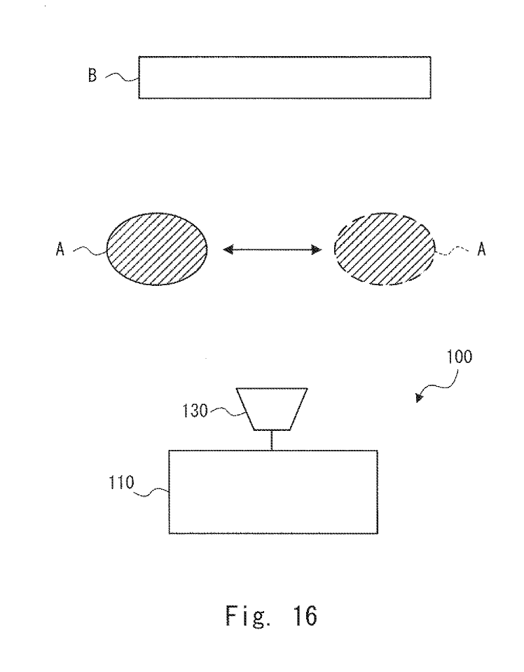

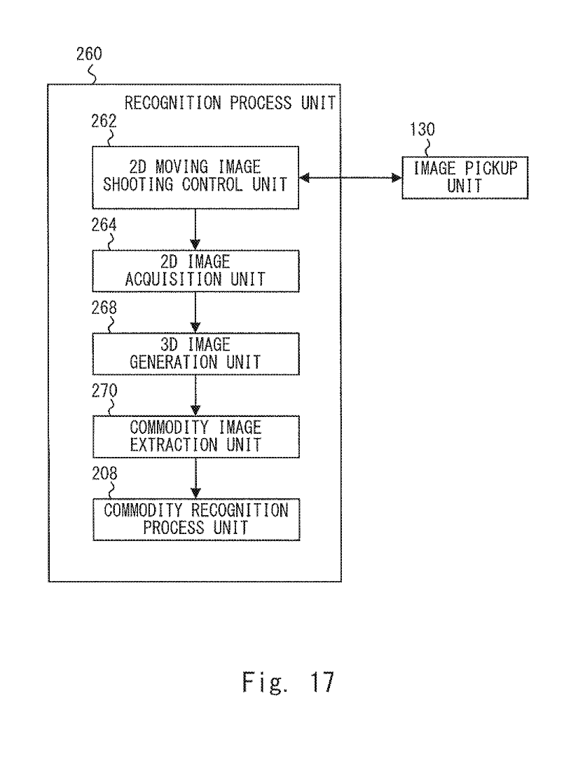

FIG. 17 is a functional block diagram of the POS terminal device 100 according to the fourth exemplary embodiment. Further, FIG. 18 is a flowchart showing processes performed by the POS terminal device 100 according to the fourth exemplary embodiment. The POS terminal device 100 according to the fourth exemplary embodiment includes a recognition process unit 260. The recognition process unit 260 includes a 2D moving image shooting control unit 262, a 2D image acquisition unit 264, a 3D image generation unit 268, a commodity image extraction unit 270, and a commodity recognition process unit 208.

The 2D moving image shooting control unit 262 makes the image pickup unit 130 take a 2D moving image including a commodity image (S402). Specifically, the 2D moving image shooting control unit 262 controls the image pickup unit 130 to make the image pickup unit 130 takes a moving image of a commodity A pointed to the image pickup unit 130. In this process, the commodity A may be moved, for example, in the horizontal direction with respect to the POS terminal device 100, or moved so that the commodity A is rotated (rotated on its own axis) in front of the image pickup unit 130. Then, the 2D moving image shooting control unit 262 acquires the 2D moving image generated by the image pickup unit 130 and outputs the 2D moving image to the 2D image acquisition unit 264.

The 2D image acquisition unit 264 acquires a plurality of 2D images each including a commodity image from the 2D moving image (S404). Specifically, the 2D image acquisition unit 264 extracts a plurality of still images (frames) included in the 2D moving image as 2D images each including a commodity image. Then, the 2D image acquisition unit 264 outputs the plurality of extracted 2D images to the 3D image generation unit 268.

The 3D image generation unit 268 generates a 3D image including a commodity image by using the plurality of 2D images (S410). Further, the 3D image generation unit 268 outputs the generated 3D image to the commodity image extraction unit 270. When the 3D image generation unit 268 can determine the horizontal moving speed of the commodity A, the 3D image generation unit 268 may generate a 3D image including a commodity image by using a parallax in a plurality of 2D images as in the case of the above-described exemplary embodiment.

Further, the 3D image generation unit 268 may generate a 3D image from a plurality of 2D images of the commodity A taken from a plurality of viewpoints by performing modeling of the 3D shape of the commodity A. For example, the 3D image generation unit 268 can perform modeling of the 3D shape by using an SFM (Structure From Motion) technique.

Specifically, the 3D image generation unit 268 extracts feature points from each of a plurality of 2D images and performs matching between the plurality of 2D images. In this way, the 3D image generation unit 268 can estimate the position (3D coordinates) of each point of the commodity A in a 3D space. Further, the 3D image generation unit 268 may presume feature points that are presumed to have moved between the plurality of 2D images as points corresponding to the commodity A. Further, the 3D image generation unit 268 may presume feature points that are presumed to have hardly moved between the plurality of 2D images as points corresponding to the background object B. That is, the commodity A can be distinguished from the background object B in the 3D image generated by the 3D image generation unit 268.

The commodity image extraction unit 270 extracts the commodity image from the 3D image (S412). When the 3D image generation unit 268 generates the 3D image by using a parallax, the commodity image extraction unit 270 can extract the commodity image in a manner similar to the process in the step S112. Further, when the 3D image generation unit 268 generates the 3D image by performing modeling of the 3D shape of the commodity A, the commodity A can be distinguished from the background object B in the 3D image as described above. Therefore, the commodity image extraction unit 270 can extract the commodity image.

The commodity recognition process unit 208 performs a commodity recognition process by using the commodity image extracted by the commodity image extraction unit 270 as in the case of the process in the step S114 (S414). Note that the commodity image could include information indicating the 3D shape of the commodity A. Therefore, as commodity feature data includes data related to the 3D shape, the commodity recognition process unit 208 can perform a commodity recognition process by using this 3D shape.

As explained above, similarly to the POS terminal device 100 according to the first exemplary embodiment, the POS terminal device 100 according to the fourth exemplary embodiment performs a process for recognizing a commodity by using a 3D image including a commodity image. Therefore, similarly to the first exemplary embodiment, the POS terminal device 100 according to the fourth exemplary embodiment can improve the recognition rate of commodities even further. Further, since the distance sensor is not used, a 3D image can be generated without performing a complicated process such as an aligning process which is necessary when the distance sensor is used.

Further, the POS terminal device 100 according to the fourth exemplary embodiment is configured so that the POS terminal device 100 generates a 3D image by using only one image pickup unit 130. Therefore, in comparison to the first exemplary embodiment, the number of image pickup units 130 can be reduced. Further, the POS terminal device 100 according to the fourth exemplary embodiment is configured so that the POS terminal device 100 generates a 3D image without moving the image pickup unit 130 to the left/right. Therefore, in comparison to the second and third exemplary embodiments, the structure can be simplified.

### Fifth Exemplary Embodiment

Next, a fifth exemplary embodiment is explained. The fifth exemplary embodiment differs from the first exemplary embodiment in that the POS terminal device 100 performs, in addition to the recognition process, start control for controlling whether a commodity recognition process should be started or not. It should be noted that the configuration according to the fifth exemplary embodiment can be applied to the other exemplary embodiments as well as the first exemplary embodiment.

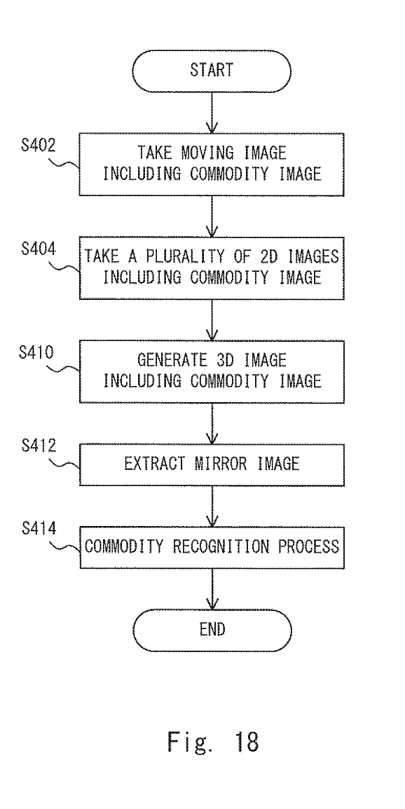

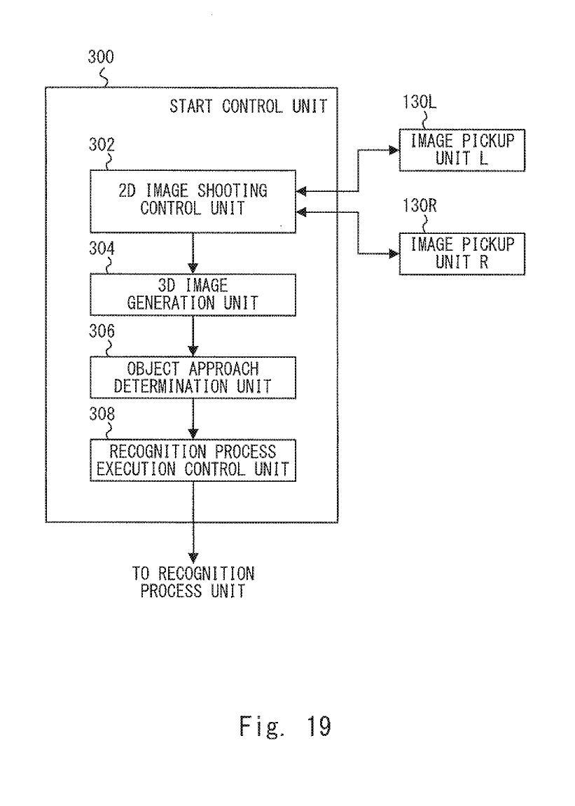

FIG. 19 is a functional block diagram showing a start control unit 300 of a POS terminal device 100 according to the fifth exemplary embodiment. Further, FIG. 20 is a flowchart showing processes performed by the start control unit 300 of the POS terminal device 100 according to the fifth exemplary embodiment. The start control unit 300 includes a 2D image shooting control unit 302, a 3D image generation unit 304, an object approach determination unit, and a recognition process execution control unit 308. The start control unit 300 determines whether or not an object is approaching (i.e., is moved to the vicinity of) the image pickup unit 130 and controls whether or not the start control unit 300 should make the recognition process unit 200 perform the recognition process.

Note that similarly to the above-described recognition process unit, the start control unit 300 can be implemented by, for example, executing a program under the control of the control unit 112. More specifically, the start control unit 300 may be implemented by, for example, executing a program stored in the storage unit 114 under the control of the control unit 112. Further, each component does not necessarily have to be implemented by software by using a program. That is, each component may be implemented by any combination of hardware, firmware, software, and the like.

The start control unit 300 acquires a 3D image (S502). Specifically, similarly to the 2D image shooting control unit 202, the 2D image shooting control unit 302 makes the image pickup unit L 130L take a 2D image ImL including a commodity image from a left-side viewpoint. Further, similarly to the 2D image shooting control unit 202, the 2D image shooting control unit 302 makes the image pickup unit R 130R take a 2D image ImR including a commodity image from a right-side viewpoint. Similarly to the 3D image generation unit 204, the 3D image generation unit 304 generates a 3D image by using the 2D images ImL and ImR. The 3D image generation unit 304 outputs the generated 3D image to the object approach determination unit 306. In this way, the start control unit 300 acquires the 3D image.

The object approach determination unit determines whether or not an object is moved to or within a threshold Th2 (a second threshold) by using the 3D image (S504). For example, the object approach determination unit 306 analyzes the 3D image and thereby determines whether or not there is a pixel indicating a distance from the image pickup unit 130 that is equal to or shorter than the threshold Th2. When there is a pixel indicating a distance equal to or shorter than threshold Th2, the object approach determination unit 306 determines that an object is approaching (i.e., is moved to the vicinity of) the image pickup unit 130. On the other hand, when there is no pixel indicating a distance equal to or shorter than threshold Th2, the object approach determination unit 306 determines that no object is approaching (i.e., is moved to the vicinity of) the image pickup unit 130.

Note that the threshold Th2 is determined with consideration given to the distance from the image pickup unit 130 to a commodity (an object) in a situation in which a salesclerk or the like attempts to make the image pickup unit 130 recognize a commodity by pointing the commodity to the image pickup unit 130. Further, the threshold Th2 is determined so that no object is present between the image pickup unit 130 and the position corresponding to the threshold Th2 unless a salesclerk or the like points a commodity to the image pickup unit 130. Further, the threshold Th2 may be greater than the threshold Th1.

When it is determined that an object is moved to or within the threshold Th2 by the object approach determination unit 306 (Yes at S504), the recognition process execution control unit 308 controls the recognition process unit 200 so that the recognition process unit 200 starts a commodity recognition process (S506). On the other hand, when it is determined that no object is moved to or within the threshold Th2 by the object approach determination unit 306 (No at S504), the recognition process execution control unit 308 determines whether or not the recognition process unit 200 is performing a commodity recognition process (S508). When the recognition process unit 200 is not performing a commodity recognition process (No at S508), the process returns to the step S502.

On the other hand, when the recognition process unit 200 is performing a commodity recognition process (Yes at S508), the recognition process execution control unit 308 controls the recognition process unit 200 so that the recognition process unit 200 terminates the commodity recognition process (S510). That is, the process of the start control unit 300 may be performed at all times when the POS terminal device 100 is in operation. Even when an object (a commodity) approaches (i.e., is moved to the vicinity of) the image pickup unit 130 and hence a process for recognizing a commodity by the recognition process unit 200 is started, the start control unit 300 controls the recognition process unit 200 so that the recognition process unit 200 terminates the commodity recognition process when the recognition process is finished or when the object (the commodity) is moved away from the image pickup unit 130 (i.e., if the distance from the image pickup unit 130 to the object exceeds the threshold Th2) during the recognition process.

As described above, the POS terminal device 100 according to the fifth exemplary embodiment performs a commodity recognition process only when an object (a commodity) approaches (i.e., is moved to the vicinity of) the image pickup unit 130. As the commodity recognition process is performed, the load on the POS terminal device 100 (in particular, the load on the image pickup unit 130, the control unit 112, and the storage unit 114) increases. Therefore, by adopting the above-described configuration, it is possible to reduce the load on the resources of the POS terminal device 100 when there is no need to perform the commodity recognition process. Note that the term “resources” include network resources in addition to the hardware resources of the POS terminal device 100 itself.

### Sixth Exemplary Embodiment

Next, a sixth exemplary embodiment is explained. The sixth exemplary embodiment differs from the first exemplary embodiment in that the POS terminal device 100 does not perform the commodity recognition process as described below. It should be noted that the configuration according to the sixth exemplary embodiment can be applied to the other exemplary embodiments as well as the first exemplary embodiment.

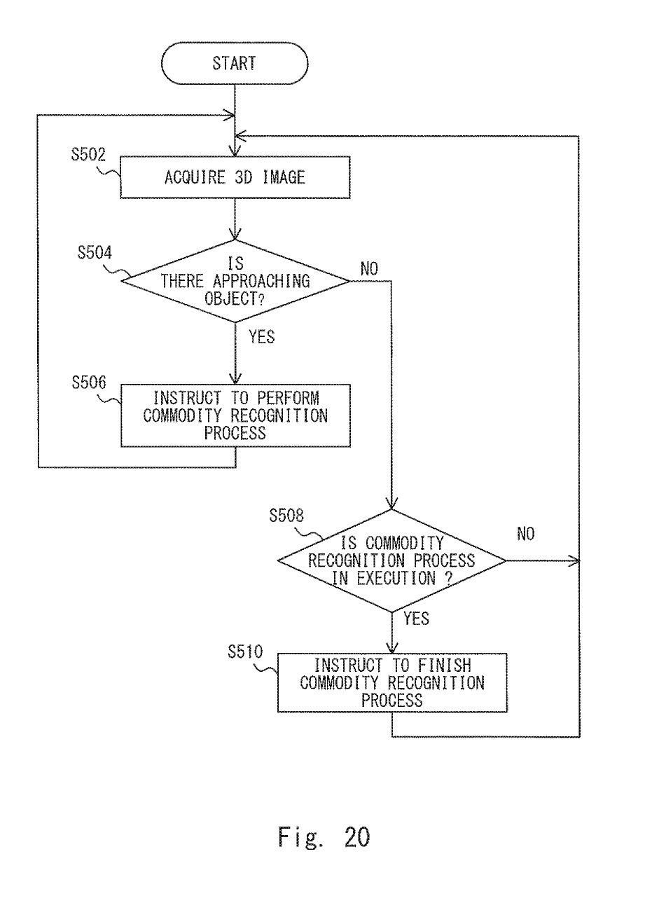

FIG. 21 shows a POS system 400 according to the sixth exemplary embodiment. As shown in FIG. 21, the POS system 400 includes a POS terminal device 100 and a management device 420. The POS terminal device 100 is connected to the management device 420 so that they can communicate with each other. The communication between them may be wired communication or wireless communication, and various communication standards can be used. The POS terminal device 100 and the management device 420 may be connected with each other through a network (e.g., a wireless LAN (Local Area Network), the Internet, or the like). Alternatively, the POS terminal device 100 and the management device 420 may be connected with each other through a short-range wireless communication system such as infrared communication or Bluetooth (Registered Trademark).

The hardware configuration of the POS terminal device 100 according to the sixth exemplary embodiment is substantially identical to that of the POS terminal device 100 according to the first exemplary embodiment. The POS terminal device 100 communicates with the management device 420 by using a communication device 116. For this, the communication device 116 carries out processes necessary for communicating with the management device 420.

The management device 420 is an information processing device that manages commodity information and the like. The management device 420 may be installed in a store in which the POS terminal device 100 is installed. Further, the management device 420 may collectively manage each of a plurality of POS terminal devices 100 installed in respective stores. In such a case, the management device 420 can be installed in a place different from the stores in which the POS terminal devices 100 are installed. Further, the management device 420 may be, for example, a server and, in particular, a cloud server.

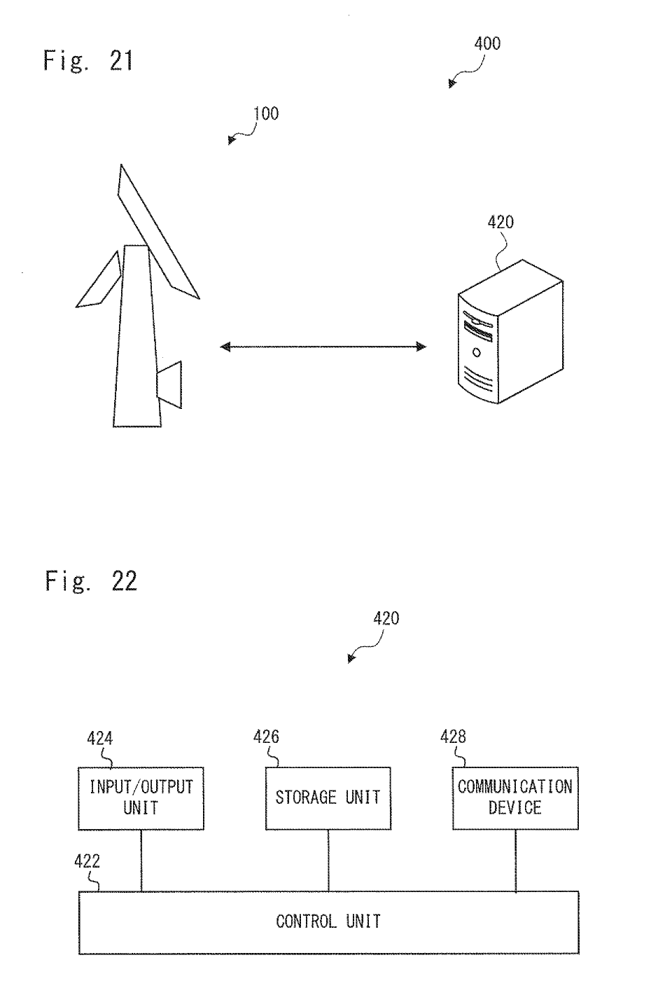

FIG. 22 shows a hardware configuration of the management device 420 according to the sixth exemplary embodiment. The management device 420 includes: a control unit 422 such as a CPU, an input/output unit 424, which is a user interface such as a touch panel, an LCD, and a keyboard; a storage unit 426 such as a memory and a hard disk drive; and a communication device 428. The communication device 428 performs processes necessary for communicating with the POS terminal device(s) 100 (or communicating with another management device 420).

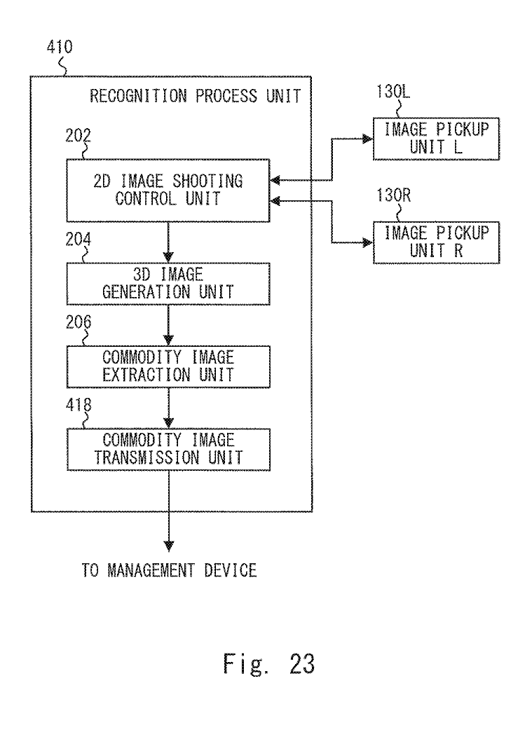

FIG. 23 is a functional block diagram of the POS terminal device 100 according to the sixth exemplary embodiment. The POS terminal device 100 includes a recognition process unit 410. The recognition process unit 410 includes a 2D image shooting control unit 202, a 3D image generation unit 204, a commodity image extraction unit 206, and a commodity image transmission unit 418. As described above, the recognition process unit 410 can be implemented by, for example, executing a program under the control of the control unit 112.

The recognition process unit 410 according to the sixth exemplary embodiment differs from the recognition process unit 200 according to the first exemplary embodiment in that the recognition process unit 410 does not include the commodity recognition process unit 208 and includes the commodity image transmission unit 418. The commodity image extraction unit 206 outputs an extracted commodity image to the commodity image transmission unit 418. The commodity image transmission unit 418 transmits the commodity image (image data of the commodity image) to the management device 420. Note that the commodity image transmission unit 418 may also transmit the current time and the identification information of the POS terminal device 100 and the like to the management device 420 when the commodity image transmission unit 418 transmits the commodity image to the management device 420.

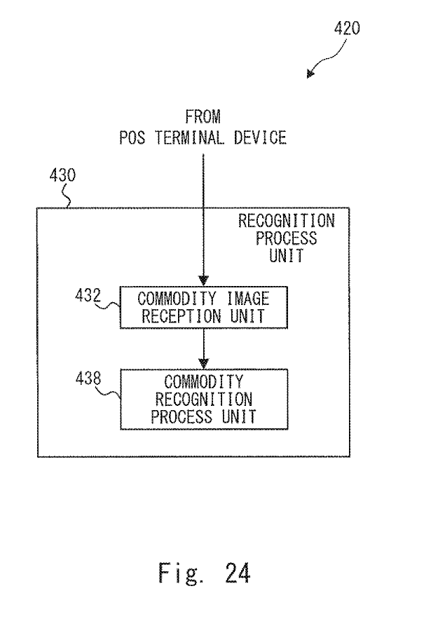

FIG. 24 is a functional block diagram of the management device 420 according to the sixth exemplary embodiment. The management device 420 includes a recognition process unit 430. Further, the recognition process unit 430 includes a commodity image reception unit 432 and a commodity recognition process unit 438.

Note that the recognition process unit 430 can be implemented by, for example, executing a program under the control of the control unit 422. More specifically, the recognition process unit 430 may be implemented by, for example, executing a program stored in the storage unit 426 under the control of the control unit 422. Further, each component does not necessarily have to be implemented by software by using a program. That is, each component may be implemented by any combination of hardware, firmware, software, and the like. Further, each component in the recognition process unit 430 may be implemented by using, for example, an integrated circuit that can be programed by a user, such as an FPGA (field-programmable gate array) and a microcomputer. In such a case, a program formed from each of the above-described components may be implemented by using this integrated circuit.

The commodity image reception unit 432 receives the commodity image (commodity image data) transmitted by the POS terminal device 100 and outputs the received commodity image to the commodity recognition process unit 438. The commodity recognition process unit 438 has substantially the same function as that of the commodity recognition process unit 208 according to the first exemplary embodiment. Therefore, the commodity recognition process unit 438 performs a commodity recognition process by using the commodity image extracted by the commodity image extraction unit 206 as in the case of the above-described first exemplary embodiment. Further, the management device 420 transmits obtained commodity information to the POS terminal device 100. The POS terminal device 100 performs a settlement process (or a payment process) and the like of the commodity by using the commodity information received from the management device 420.

By having the management device 420 perform a commodity recognition process rather than having a POS terminal device 100 perform the process as explained above in the sixth exemplary embodiment, each of the POS terminal devices 100 does not need to store a reference commodity information necessary for the commodity recognition process. Further, the POS terminal device 100 does not need to perform the commodity recognition process. Therefore, the resources of the POS terminal device 100 can be saved. Further, this exemplary embodiment can be applied even to a POS terminal device 100 equipped with a few resources such as a tablet terminal. Further, the commodity image is extracted by the commodity image extraction unit 206 even in the sixth exemplary embodiment. Therefore, similarly to the first exemplary embodiment, it is possible to reduce the load on the resources, improve the processing speed, improve the recognition rate of commodities, recognize the projection/depression shape of a commodity, and recognize the size (the volume) of a commodity in the commodity recognition process performed by the management device 420.

Further, as described above, in the commodity image extracted by the commodity image extraction unit 206, the background is eliminated from the 3D image. Therefore, the amount of data of the commodity image is smaller than the amount of data of the 3D image including the background image. In the case in which the commodity recognition process is performed by the management device 420, if the POS terminal device 100 transmits image data of a 3D image including a background image to the management device 420, the amount of transmitted data is large and hence the load on the communication network increases. In contrast to this, if the POS terminal device 100 transmits image data of a commodity image to the management device 420, the amount of transmitted data is small and hence the load on the communication network is reduced.

### MODIFIED EXAMPLES

Note that the present invention is not limited to the aforementioned exemplary embodiments and may be changed as appropriate without departing from the spirit of the present invention. For example, the order of processes in the above-described flowchart can be changed as appropriate. Further, at least one of a plurality of processes in the above-described flowchart may be omitted. For example, in the flowchart shown in FIG. 6, the process in the step S102 may be performed after the process in the step S104. This also holds true in the flowchart shown in FIG. 11. That is, the order of the left and right shooting processes may be arbitrarily changed.

Further, although the configuration according to this exemplary embodiment is applied to a POS terminal device, the entity to which the present invention applied is not limited to the POS terminal device. For example, the present invention can be applied to general object recognition apparatuses such as those used to sorting out baggage in warehouse or the like, and applied to systems including such object recognition apparatus.

Further, the POS terminal device 100 according to this exemplary embodiment can be applied to, for example, a self-checkout counter. When a customer uses a POS terminal as in the case of the self-checkout counter, the customer is not accustomed to a task of making a reader device read a barcode attached to a commodity. Therefore, in the self-checkout counter, a method in which no barcode is used is desired. That is, a method in which a commodity itself is read (i.e., recognized) is desired. Therefore, by using the POS terminal device 100 according to this exemplary embodiment for the self-checkout counter, problems that could be caused when commodities themselves are read (i.e., recognized) as described above are solved.

Further, as described above, the POS terminal device 100 according to this exemplary embodiment can be applied to a terminal equipped with a few resources such as a tablet terminal (a tablet POS). In such a case, the image pickup unit 130 may not be disposed inside the tablet terminal, but may be provided as a device separate from (external to) the tablet terminal.

Further, in the first exemplary embodiment and the like, the viewpoints from the left and right are used as example viewpoints. However, the present invention is not limited to this configuration. For example, viewpoints from the top and bottom may be used, provided that a 3D image can be generated from them. Further, although the image pickup unit 130 moves in the horizontal direction in the second exemplary embodiment, the image pickup unit 130 may move, for example, in the vertical direction (up/down direction).

Further, although the image pickup unit 130 takes a 2D image at each of the left-side and right-side positions L and R in the second exemplary embodiment, the present invention is not limited to this configuration. For example, the image pickup unit 130 may take a moving image (i.e., a moving picture) while the image pickup unit 130 is moving. Further, the 3D image generation unit may generate a 3D image using an arbitrary number of still images among the plurality of frames (still images) constituting the taken moving image. In this process, the 3D image generation unit can calculate the distance that the image pickup unit 130 has moved from when a given still image is taken to when the next still image is taken by recognizing the positions of the image pickup unit 130 at the times when these still images are taken. Therefore, the 3D image generation unit can generate a 3D image by using the above-described relational expression “d=f×D/Z”, where D represents the moving distance.

Further, for example, the configuration according to the first exemplary embodiment may be combined with the configuration according to the sixth exemplary embodiment. That is, a commodity recognition process may also be performed in the POS terminal device 100 according to the sixth exemplary embodiment. In other words, the POS terminal device 100 according to the sixth exemplary embodiment may include the commodity recognition process unit 208. In this case, when the load on the POS terminal device 100 increases beyond a predefined first load value, the POS terminal device 100 may transmit a commodity image to the management device 420 and the management device 420 may perform a commodity recognition process. On the other hand, when the load on the management device 420 increases beyond a predefined second load value or when the load on the communication network increases beyond a predefined third load value, the POS terminal device 100 may not transmit the commodity image to the management device 420 and perform the commodity recognition process by the POS terminal device 100 itself. Similarly, the configuration of the sixth exemplary embodiment may be combined with the configuration of an exemplary embodiment other than the first exemplary embodiment.

As described above, the load can be distributed as appropriate according to the load on the POS terminal device 100, the load on the management device 420, and the load on the communication network. In such a case, the POS terminal device 100 or the management device 420 may include means for measuring the loads on the POS terminal device 100, the management device 420, and the communication network, and means for comparing the measured loads with the first to third load values.

Further, in the above-described exemplary embodiments, the commodity image extraction unit extracts the commodity image from the 3D image. However, this process of “extraction” is not limited to the process for extracting a commodity image from a 3D image. That is, the commodity image extraction unit may determine which area in the 3D image the commodity image corresponds to and thereby select the commodity image in the 3D image. In this case, the commodity image process unit may perform the commodity image process by using the selected commodity image. In other words, in this exemplary embodiment, “extracting a commodity image” means a concept including a process for selecting a commodity image in a 3D image.

Further, this program can be stored in various types of non-transitory computer readable media and thereby supplied to computers. The non-transitory computer readable media includes various types of tangible storage media. Examples of the non-transitory computer readable media include a magnetic recording medium (such as a flexible disk, a magnetic tape, and a hard disk drive), a magneto-optic recording medium (such as a magneto-optic disk), a CD-ROM (Read Only Memory), a CD-R, and a CD-R/W, and a semiconductor memory (such as a mask ROM, a PROM (Programmable ROM), an EPROM (Erasable PROM), a flash ROM, and a RAM (Random Access Memory)). Further, the program can be supplied to computers by using various types of transitory computer readable media. Examples of the transitory computer readable media include an electrical signal, an optical signal, and an electromagnetic wave. The transitory computer readable media can be used to supply programs to computer through a wire communication path such as an electrical wire and an optical fiber, or wireless communication path.

### (Supplementary Notes)

In relation to the above-described exemplary embodiments, the following supplementary notes are also disclosed.

### (Supplementary Note 1)

An image processing method comprising:

generating a plurality of two-dimensional images by shooting a commodity from a plurality of viewpoints, each of the plurality of two-dimensional images corresponding to a respective one of the plurality of viewpoints;

generating a three-dimensional image including an image of the commodity by using the plurality of generated two-dimensional images; and extracting the image of the commodity by using the three-dimensional image.

### (Supplementary Note 2)

The image processing method described in Supplementary note 1, further comprising extracting the image of the commodity by eliminating an image of a background other than the commodity.

### (Supplementary Note 3)

The image processing method described in Supplementary note 1 or 2, further comprising performing a process for recognizing the commodity based on the extracted image of the commodity.

### (Supplementary Note 4)

The image processing method described in Supplementary note 3, further comprising recognizing a projection/depression shape of the commodity in the extracted image of the commodity, and performing the process for recognizing the commodity based on the recognized projection/depression shape of the commodity.

### (Supplementary Note 5)

The image processing method described in any one of Supplementary notes 1 to 4, further comprising:

calculating a distance to each point in the shot commodity and the shot background by using the plurality of two-dimensional images; and

extracting an image area corresponding to points whose calculated distances are equal to or shorter than a predefined first threshold from the three-dimensional image as the image of the commodity.

### (Supplementary Note 6)

The image processing method described in Supplementary note 5, further comprising:

calculating a size of the extracted image of the commodity in the three-dimensional image;

recognizing a size of the commodity based on the calculated size of the image of the commodity and the calculated distance to each point in the commodity; and

performing the process for recognizing the commodity based on the recognized size of the commodity.

### (Supplementary Note 7)

The image processing method described in Supplementary note 5 or 6, further comprising:

determining whether the commodity has approached so that the calculated distance is equal to or shorter than a predefined second threshold; and

performing the extracting process when it is determined that the commodity has approached.

### (Supplementary Note 8)

The image processing method described in any one of Supplementary notes 1 to 7, further comprising shooting the commodity from a plurality of viewpoints by moving one image pickup device, and generating a plurality of two-dimensional images, each of the plurality of two-dimensional images corresponding to a respective one of the plurality of viewpoints.

### (Supplementary Note 9)

The image processing method described in any one of Supplementary notes 1 to 7, further comprising shooting the commodity from a plurality of viewpoints by shooting a plurality of mirror images, each of the plurality of mirror images being reflected on a respective one of a plurality of mirrors disposed in front of the one image pickup device, and generating a plurality of two-dimensional images, each of the plurality of two-dimensional images corresponding to a respective one of the plurality of viewpoints.

### (Supplementary Note 10)

The image processing method described in any one of Supplementary notes 1 to 7, further comprising shooting the commodity by each of a plurality of image pickup devices from their respective viewpoints, and generating a plurality of two-dimensional images, each of the plurality of two-dimensional images corresponding to a respective one of the plurality of viewpoints.

### (Supplementary Note 11)

A program for causing a computer to execute: a step of generating a plurality of two-dimensional images by making at least one image pickup means shoot a commodity from a plurality of viewpoints, each of the plurality of two-dimensional images corresponding to a respective one of the plurality of viewpoints;

a step of generating a three-dimensional image including an image of the commodity by using the plurality of generated two-dimensional images; and

a step of extracting the image of the commodity by using the three-dimensional image.

### (Supplementary Note 12)

The program described in Supplementary note 11, further causing the computer to execute a step of extracting the image of the commodity by eliminating an image of a background other than the commodity.

### (Supplementary Note 13)

The program described in Supplementary note 11 or 12, further causing the computer to execute a step of performing a process for recognizing the commodity based on the extracted image of the commodity.

### (Supplementary Note 14)

The program described in Supplementary note 13, further causing the computer to execute a step of recognizing a projection/depression shape of the commodity in the extracted image of the commodity, and performing the process for recognizing the commodity based on the recognized projection/depression shape of the commodity.

### (Supplementary Note 15)

The program described in any one of Supplementary notes 11 to 14, further causing the computer to execute:

a step of calculating a distance to each point in the shot commodity and the shot background by using the plurality of two-dimensional images; and

a step of extracting an image area corresponding to points whose calculated distances are equal to or shorter than a predefined first threshold from the three-dimensional image as the image of the commodity.

### (Supplementary Note 16)

The program described in Supplementary note 15, further causing the computer to execute:

a step of calculating a size of the extracted image of the commodity in the three-dimensional image;

a step of recognizing a size of the commodity based on the calculated size of the image of the commodity and the calculated distance to each point in the commodity; and

a step of performing the process for recognizing the commodity based on the recognized size of the commodity.

### (Supplementary Note 17)

The program described in Supplementary note 15 or 16, further causing the computer to execute a step of determining whether the commodity has approached so that the calculated distance is equal to or shorter than a predefined second threshold, wherein

the extraction step is performed when it is determined that the commodity has approached.

Although the present invention is explained above with reference to exemplary embodiments, the present invention is not limited to the above-described exemplary embodiments. Various modifications that can be understood by those skilled in the art can be made to the configuration and details of the present invention within the scope of the invention.

This application is based upon and claims the benefit of priority from Japanese patent applications No. 2014-057377, filed on Mar. 20, 2014, the disclosure of which is incorporated herein in its entirety by reference.

### REFERENCE SIGNS LIST

1 POS TERMINAL DEVICE
2 IMAGE PICKUP UNIT
4 3D IMAGE GENERATION UNIT
6 COMMODITY IMAGE EXTRACTION UNIT
100 POS TERMINAL DEVICE
110 INFORMATION PROCESSING DEVICE
130 IMAGE PICKUP UNIT
140 OPTICAL UNIT
142L LEFT-SIDE MIRROR
142R RIGHT-SIDE MIRROR
144L LEFT-SIDE MIRROR
144R RIGHT-SIDE MIRROR
200 RECOGNITION PROCESS UNIT
202 2D IMAGE SHOOTING CONTROL UNIT
204 3D IMAGE GENERATION UNIT
206 COMMODITY IMAGE EXTRACTION UNIT
208 COMMODITY RECOGNITION PROCESS UNIT
220 RECOGNITION PROCESS UNIT
222 2D IMAGE SHOOTING CONTROL UNIT
240 RECOGNITION PROCESS UNIT
242 2D IMAGE SHOOTING CONTROL UNIT
244 MIRROR IMAGE EXTRACTION UNIT
260 RECOGNITION PROCESS UNIT
262 2D MOVING IMAGE SHOOTING CONTROL UNIT
264 2D IMAGE ACQUISITION UNIT
268 3D IMAGE GENERATION UNIT
270 COMMODITY IMAGE EXTRACTION UNIT
300 START CONTROL UNIT
302 2D IMAGE SHOOTING CONTROL UNIT
304 3D IMAGE GENERATION UNIT
306 OBJECT APPROACH DETERMINATION UNIT
308 RECOGNITION PROCESS EXECUTION CONTROL UNIT
400 POS SYSTEM
410 RECOGNITION PROCESS UNIT
418 COMMODITY IMAGE TRANSMISSION UNIT
420 MANAGEMENT DEVICE
430 RECOGNITION PROCESS UNIT
432 COMMODITY IMAGE RECEPTION UNIT
438 COMMODITY RECOGNITION PROCESS UNIT

What is claimed is:

1. A POS terminal device comprising:
at least one camera configured to generate a plurality of two-dimensional images by shooting a commodity from a plurality of viewpoints, each of the plurality of two-dimensional images corresponding to a respective one of the plurality of viewpoints;
at least one memory storing instructions, and
at least one processor configured to execute the instructions to:
generate a three-dimensional image including an image of the commodity by using the plurality of two-dimensional images generated by the at least one camera; and
extract the image of the commodity by using the three-dimensional image.

2. The POS terminal device according to claim 1, wherein the at least one processor is further configured to execute the instructions to extract the image of the commodity by eliminating an image of a background other than the commodity.

3. The POS terminal device according to claim 1, wherein the at least one processor is further configured to execute the instructions to perform a process for recognizing the commodity based on the extracted image of the commodity.

4. The POS terminal device according to claim 3, wherein the at least one processor is further configured to execute the instructions to recognize a projection/depression shape of the commodity in the extracted image of the commodity, and perform the process for recognizing the commodity based on the recognized projection/depression shape of the commodity.

5. The POS terminal device according to claim 1, wherein the at least one processor is further configured to execute the instructions to:
calculate a distance to each point in the shot commodity and the shot background by using the plurality of two-dimensional images; and
extract an image area corresponding to points whose calculated distances are equal to or shorter than a predefined first threshold from the three-dimensional image as the image of the commodity.

6. The POS terminal device according to claim 5, wherein the at least one processor is further configured to execute the instructions to:
calculate a size of the extracted image of the commodity in the three-dimensional image;
recognize a size of the commodity based on the calculated size of the image of the commodity and the calculated distance to each point in the commodity, and
perform the process for recognizing the commodity based on the recognized size of the commodity.

7. The POS terminal device according to claim 5, wherein the at least one processor is further configured to execute the instructions to:
determine whether the commodity has approached so that the calculated distance is equal to or shorter than a predefined second threshold; and
perform the extracting process when it is determined that the commodity has approached.

8. The POS terminal device according to claim 1, wherein
the at least one camera includes one image pickup device, and
the at least one camera is configured to shoot the commodity from a plurality of viewpoints by moving the image pickup device, and thereby generate a plurality of two-dimensional images, each of the plurality of two-dimensional images corresponding to a respective one of the plurality of viewpoints.

9. The POS terminal device according to claim 1, wherein
the at least one camera includes one image pickup device, and
the at least one camera is configured to shoot the commodity from a plurality of viewpoints by shooting a plurality of mirror images, each of the plurality of mirror images being reflected on a respective one of a plurality of mirrors disposed in front of the one image pickup device, and thereby generate a plurality of two-dimensional images, each of the plurality of two-dimensional images corresponding to a respective one of the plurality of viewpoints.

10. The POS terminal device according to claim 1, wherein
the at least one camera includes a plurality of image pickup devices, and
the at least one camera is configured to shoot the commodity by each of the plurality of image pickup devices from its respective viewpoint, and thereby generate a plurality of two-dimensional images, each of the plurality of two-dimensional images corresponding to a respective one of the plurality of viewpoints.

11. The POS terminal device according to claim 1, further comprising a communication device configured to transmit data representing the extracted image of the commodity to a management device, the management device being configured to perform a process for recognizing the commodity based on the extracted image of the commodity.

12. A POS system comprising:
a POS terminal device according to claim 1, and
a management device configured to communicate with the POS terminal device.

13. The POS system according to claim 12, wherein
the POS terminal device is connected with the management device through a communication network,
when a load on the POS terminal device increases beyond a predefined first load value, the POS terminal device transmits data representing the extracted image of the commodity to the management device and the management device performs the process for recognizing the commodity, and
when a load on the management device increases beyond a predefined second load value or when a load on the communication network increases beyond a predefined third load value, the POS terminal device does not transmit the data representing the extracted image of the commodity to the management device and the at least one processor is further configured to execute the instructions to perform the process for recognizing the commodity.

14. An image processing method comprising:
generating a plurality of two-dimensional images by shooting a commodity from a plurality of viewpoints, each of the plurality of two-dimensional images corresponding to a respective one of the plurality of viewpoints;
generating a three-dimensional image including an image of the commodity by using the plurality of generated two-dimensional images; and
extracting the image of the commodity by using the three-dimensional image.

15. A non-transitory computer readable medium storing a program for causing a computer to execute:
a step of generating a plurality of two-dimensional images by making at least one camera shoot a commodity from a plurality of viewpoints, each of the plurality of two-dimensional images corresponding to a respective one of the plurality of viewpoints;
a step of generating a three-dimensional image including an image of the commodity by using the plurality of generated two-dimensional images; and
a step of extracting the image of the commodity by using the three-dimensional image.
